(19) United States
(12) Patent Application Publication
(10) Pub. No.: US 2014/0037951 A1
(43) Pub. Date: Feb. 6, 2014

(54) PRESSURE-SENSITIVE ADHESIVE COMPOSITION, PRESSURE-SENSITIVE ADHESIVE LAYER, PRESSURE-SENSITIVE ADHESIVE SHEET, AND OPTICAL FILM

(71) Applicant: NITTO DENKO CORPORATION, Osaka (JP)

(72) Inventors: Kiyoe SHIGETOMI, Osaka (JP); Ryo KANNO, Osaka (JP); Masayuki OKAMOTO, Osaka (JP); Masato YAMAGATA, Osaka (JP)

(73) Assignee: NITTO DENKO CORPORATION, Osaka (JP)

(21) Appl. No.: 13/954,192

(22) Filed: Jul. 30, 2013

(30) Foreign Application Priority Data
Jul. 31, 2012 (JP) 2012-170649
Apr. 15, 2013 (JP) 2013-085175

(51) Int. Cl. C09J 7/02

(52) U.S. Cl. CPC C09J 7/0217
USPC 428/355 AC; 524/516

(57) ABSTRACT

A pressure-sensitive adhesive composition includes: 100 parts by mass of a polymer (A) having a glass transition temperature lower than 0° C.; and 0.05 parts by mass to 20 parts by mass of a (meth)acrylic polymer (B) having a weight average molecular weight (MwB) of 1000≦MwB<30000 that contains, as monomer units, both a (meth)acrylic monomer having an alicyclic structure represented by the following general formula (1) and a monomer having a polyoxyalkylene skeleton:

CH₂═C(R¹)COOR² (1)

[wherein R¹ represents a hydrogen atom or a methyl group and R² represents an alicyclic hydrocarbon group having an alicyclic structure.]

### BACKGROUND OF THE INVENTION

1. Field of the Invention

The present invention relates to a pressure-sensitive adhesive composition, and a pressure-sensitive adhesive layer and a pressure-sensitive adhesive sheet that are made of the pressure-sensitive adhesive composition.

2. Description of the Related Art

A pressure-sensitive adhesive sheet is used for adhering adherends to each other or for fixing an article to an adherend by being firmly adhered to an adherend. At the time, reattachment of the sheet becomes difficult if the pressure-sensitive adhesive force thereof is large from the early stage of the attachment, and hence there is a demand for a pressure-sensitive adhesive tape in which: pressure-sensitive adhesive force is small in the early stage, but the force is increased over time such that large pressure-sensitive adhesive force can be obtained.

Liquid crystal displays, plasma displays, and organic EL displays, etc., becomes popular particularly in recent years. In these displays, it is essential to arrange various optical films on both the surfaces of glass substrates forming the outermost surfaces thereof. For example, a polarizing film is attached to the outermost surface of a liquid crystal panel. Other than those, various optical elements are being used in order to improve the displaying quality of displays. For example, a phase difference film for preventing coloration, a wide viewing angle film for improving the viewing angle of a liquid crystal display, and a brightness enhancement film for enhancing the contrast of a display, etc., are used. These films are collectively referred to as optical films.

When the optical film is attached to the outermost surface of a display, a pressure-sensitive adhesive is typically used. The pressure-sensitive adhesive is provided in advance on one surface of the optical film as a pressure-sensitive adhesive layer, because this method has the advantages that: the optical film can be instantly fixed to the outermost surface of the display; and a drying step for firmly fixing the optical film is not required, etc. That is, optical films of a pressure-sensitive adhesive type are generally used for attaching optical films to the outermost surfaces of liquid crystal panels. As the pressure-sensitive adhesive, acrylic pressure-sensitive adhesives are often used because they are excellent in adhesiveness, transparency, and weatherability, etc.

A pressure-sensitive adhesive to be used for the attachment of the optical film is sometimes required to have a property in which reattachment (rework) of the film can be performed. This requirement is made because: when optical films are attached to the outermost surfaces of displays, the films are often attached to incorrect positions or foreign substances are often interposed on the surfaces to be attached; and even in such a case, the film is made to be able to be attached again after being released from the outermost surface thereof. In this case, the display is reused because it is expensive, while the optical film, which is relatively inexpensive, is discarded.

With respect to the reworkability, it is needed that the pressure-sensitive adhesive force to a glass substrate forming the outermost surface of a display is smaller. However, with displays being used more and more under harsh conditions as they spread into various fields, such as mobile phones, measuring instruments, electronic watches, TVs, and in-vehicle equipment, it is required that the adhesion between an optical film and a display via a pressure-sensitive adhesive layer should have the pressure-sensitive adhesive force sufficiently resistant to the use under a high-temperature atmosphere. Accordingly, there is a demand for a pressure-sensitive adhesive whose pressure-sensitive adhesive force is, in the early stage of the attachment, as small as the extent in which rework can be performed, and thereafter the optical film and the display are adhered to each other so firmly that pop-off or peeling is not generated on the interface between the pressure-sensitive adhesive layer and the display even under a high-temperature atmosphere.

In addition, a pressure-sensitive adhesive to be used for the attachment of an optical film is required to have high transparency itself.

To meet these requirements, an acrylic pressure-sensitive adhesive composition having sufficient adhesiveness and excellent in re-releasability and a pressure-sensitive adhesive sheet using the composition have been presented (see Patent Document 1). The above pressure-sensitive adhesive composition comprises, (A) 100 parts by mass of acrylate having a C₈₋₁₃ alkyl group, (B) 10 to 90 parts by mass of acrylate having a saturated alicyclic group in its side chain, (C) 1 to 40 parts by mass of acrylate having ethylene glycol chains or propylene glycol chains whose repetition number is 2 to 23, a polymerization initiator, and a cross-linking agent; and the above pressure-sensitive adhesive sheet is obtained by radiating light onto the pressure-sensitive adhesive composition.

### PATENT DOCUMENT

[Patent Document 1] Japanese Patent Application Publication No. 2008-195753

The conventional pressure-sensitive adhesive sheet is unsatisfactory because the pressure-sensitive adhesive force, occurring over time, is poor and the adhesion reliability is deteriorated.

### SUMMARY OF THE INVENTION

The present invention has been made in view of these situations and a purpose of the invention is to provide a pressure-sensitive adhesive whose pressure-sensitive adhesive force is, in the early stage of attachment, as small as the extent in rework can be performed, and thereafter the adhesive is firmly adhered to an adherend. Another purpose of the invention is to provide a pressure-sensitive adhesive excellent in transparency.

An aspect of the present invention is a pressure-sensitive adhesive composition. The pressure-sensitive adhesive composition comprises: 100 parts by mass of a polymer (A) having a glass transition temperature lower than 0° C.; and 0.05 parts by mass to 20 parts by mass of a (meth)acrylic polymer (B) having a weight average molecular weight (MwB) of 1000≦MwB<30000 that contains, as monomer units, both a (meth)acrylic monomer having an alicyclic structure represented by the following general formula (1) and a monomer having a polyoxyalkylene skeleton:

CH₂═C(R¹)COOR² (1)

[wherein R¹ represents a hydrogen atom or a methyl group and R² represents an alicyclic hydrocarbon group having an alicyclic structure.]

In the pressure-sensitive adhesive composition of the aforementioned aspect, the polymer (A) may be an acrylic polymer.

In the pressure-sensitive adhesive composition of the aforementioned aspect, the alicyclic hydrocarbon group of the (meth)acrylic monomer having an alicyclic structure in the (meth)acrylic polymer (B) may have a bridged ring structure. In addition, the monomer having a polyoxyalkylene skeleton in the (meth)acrylic polymer (B) may be an oxyalkylene group-containing monomer in which the average added mole number of an oxyalkylene unit represented by the following general formula (2) is 3 to 40: [Formula 1]

CH₂═C(R₁)—COO—(CₘH₂ₘO)ₙ—(CₚH₂ₚO)_{q}—R₂ (2)

[wherein R¹ represents hydrogen or a methyl group, R² represents hydrogen or a monovalent organic group, m and p represent integers of 2 to 4, and n and q represent integers of 0 or 2 to 40 that are not 0 at a time.]

In the pressure-sensitive adhesive composition of the aforementioned aspect, the acrylic polymer may further contain, as a monomer unit, at least one monomer selected from the group consisting of N-vinyl cyclic amides represented by the following general formula (M1) and hydroxyl group-containing monomers:

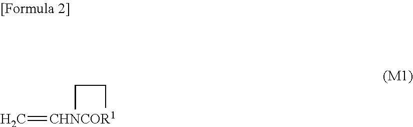

wherein R¹ is a divalent organic group.

Another aspect of the present invention is a pressure-sensitive adhesive layer. The pressure-sensitive adhesive layer is made of the pressure-sensitive adhesive composition according to any one of the aforementioned aspects. The pressure-sensitive adhesive layer according to this aspect may contain 55.0% by mass to 99.0% by mass of a solvent-insoluble component.

Still another aspect of the present invention is a pressure-sensitive adhesive sheet. The pressure-sensitive adhesive sheet comprises the pressure-sensitive adhesive layer according to any one of the aforementioned aspects.

Further, the present invention comprises an optical film with a pressure-sensitive adhesive layer made by forming the pressure-sensitive adhesive layer according to any one of the aforementioned aspects on at least one surface of the optical film.

### DETAILED DESCRIPTION OF THE INVENTION

The invention will now be described by reference to the preferred embodiments. This does not intend to limit the scope of the present invention, but to exemplify the invention.

A pressure-sensitive adhesive composition according to the present embodiment comprises: 100 parts by mass of a polymer (A) having a glass transition temperature lower than 0° C., as a pressure-sensitive composition; and 0.05 parts by mass to 20 parts by mass of a (meth)acrylic polymer (B) having a weight average molecular weight (MwB) of 1000≦MwB<30000 that contains, as monomer units, both a (meth)acrylic monomer having an alicyclic structure represented by the following general formula (1) and a monomer having a polyoxyalkylene skeleton (hereinafter, appropriately referred to as a (meth)acrylic polymer (B)):

CH₂═C(R¹)COOR² (1)

[wherein R¹ represents a hydrogen atom or a methyl group and R² represents an alicyclic hydrocarbon group having an alicyclic structure.]

Hereinafter, the polymer (A) and the (meth)acrylic polymer (B) will be described in detail.

### [Polymer (A)]

The polymer (A) is not particularly limited as far as the glass transition temperature of which is lower than 0° C., and various polymers to be generally used as a pressure-sensitive adhesive, such as an acrylic polymer, rubber polymer, silicone polymer, polyurethane polymer, and polyester polymer, etc., can be used. In particular, an acrylic polymer that is easily compatible with the (meth)acrylic polymer (B) and has high transparency is preferred.

The glass transition temperature (Tg) of the polymer (A) is lower than 0° C., preferably lower than −10° C., and more preferably lower than −40° C., and usually −80° C. or higher. If the glass transition temperature (Tg) of the polymer (A) is 0° C. or higher, it becomes difficult for the polymer to flow, and hence the increase in the pressure-sensitive adhesive force, occurring over time, is sometimes deteriorated.

The glass transition temperature is a nominal value described in documents or catalogs, etc., or a value calculated based on the following Equation (X) (Fox Equation).

1/Tg=W₁/Tg₁+W₂/Tg₂+ . . . +Wₙ/Tgₙ (X)

[wherein Tg represents the glass transition temperature (unit: K) of the polymer (A), Tgᵢ (i=1, represents the glass transition temperature (unit: K) when monomer i forms a homopolymer, and Wi (i=1, 2, . . . , n) represents a mass fraction of the monomer i in the whole monomer components.]

The above Equation (X) is adopted when the polymer (A) is formed of n types of monomer components of monomer 1, monomer 2, . . . , monomer n.

In the present specification, “the glass transition temperature when the monomer forms a homopolymer” means “the glass transition temperature of the homopolymer formed of the monomer”, i.e., means the glass transition temperature (Tg) of a polymer formed by only using a monomer (sometimes referred to as a “monomer X”) as a monomer component. Specifically, those values are described in “Polymer Handbook” (Third Edition, John Wiley & Sons, Inc, 1989). The glass transition temperatures (Tg) of homopolymers, which are not described in the above document, means the values obtained, for example, from the following measuring method. That is, into a reactor provided with a thermometer, a stirrer, a nitrogen inlet pipe, and a reflux cooling pipe, 100 parts by mass of the monomer X, 0.2 parts by mass of 2,2′-azobisisobutyronitrile, and 200 parts by mass of ethyl acetate, as a polymerization solvent, are placed; and the mixture is stirred for 1 hour while a nitrogen gas is being introduced. After the oxygen in the polymerization system is removed in this way, the mixture is heated to 63° C. to react with each other for 10 hours. Subsequently, the mixture is cooled to room temperature to obtain a homopolymer solution having a solid concentration of 33% by mass. Subsequently, this homopolymer solution is made to flow on a release liner to be coated thereon, and the solution is then dried to make a test sample (sheet-shaped homopolymer) having a thickness of approximately 2 mm. Subsequently, 1 to 2 mg of this test sample is weighed and placed in an aluminum open cell, so that Reversing Heat Flow (specific heat component) behaviors of the homopolymer are obtained by using a temperature-modulated DSC (product name: “Q-2000” made by TA Instruments Inc.) at a heating rate of 5° C./min under 50 ml/min of a nitrogen flow rate atmosphere. With reference to JIS-K-7121, the temperature at the point where a straight line, located at the same distance in the vertical axis direction from a straight line obtained by extending the base line on the low-temperature side of the obtained Reversing Heat Flow and from a straight line obtained by extending the base line on the high-temperature side thereof, and a curved line, located at the portion where the glass transition temperature is changed in a stepwise shape, intersect with each other is determined to be the glass transition temperature (Tg) of the homopolymer.

The weight average molecular weight (MwA) of the polymer (A) is, for example, 30,000 to 5,000,000, preferably 100,000 to 2,000,000, and more preferably 200,000 to 1,000,000. If the weight average molecular weight (MwA) is less than 30,000, the cohesive force of the pressure-sensitive adhesive may become insufficient, and hence the adhesion reliability is sometimes deteriorated. On the other hand, if the weight average molecular weight (MwA) is more than 5,000,000, the flow property of the pressure-sensitive adhesive becomes poor, and hence the increase in the pressure-sensitive adhesive force, occurring over time, is sometimes deteriorated.

### [Acrylic Polymer]

Hereinafter, an acrylic polymer, which is a specifically preferred example of the polymer (A), will be described in detail.

The acrylic polymer is a polymer containing, as a monomer unit, a (meth)acrylic acid alkyl ester having, for example, a C₁₋₂₀ linear or branched alkyl group in an amount of 50% by mass or more. Alternatively, the acrylic polymer may have a structure formed only by a (meth)acrylic acid alkyl ester having a C₁₋₂₀ alkyl group or by a combination of two or more thereof. A method of obtaining the acrylic polymer is not particularly limited, but the polymer can be obtained by applying various polymerization methods that are generally used as a method of synthesizing an acrylic polymer, such as solution polymerization, emulsion polymerization, block polymerization, suspension polymerization, and radiation curing polymerization.

The ratio of the (meth)acrylic acid alkyl ester having a C₁₋₂₀ linear or branched alkyl group to the total mass of the monomer components for preparing the acrylic polymer is 50% by mass to 99.9% by mass, preferably 60% by mass to 98% by mass, and more preferably 70% by mass to 95% by mass.

Examples of the (meth)acrylic acid alkyl ester having a C₁₋₂₀ linear or branched alkyl group include, for example: (meth)acrylic acid C₁₋₂₀ alkyl esters [preferably (meth)acrylic acid C₂₋₁₄ alkyl esters, and more preferably (meth)acrylic acid C₂₋₁₀ alkyl esters], such as (meth)acrylic acid methyl, (meth)acrylic acid ethyl, (meth)acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid heptyl, (meth)acrylic acid octyl, (meth)acrylic acid 2-ethylhexyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, (meth)acrylic acid dodecyl, (meth)acrylic acid tridecyl, (meth)acrylic acid tetradecyl, (meth)acrylic acid pentadecyl, (meth)acrylic acid hexadecyl, (meth)acrylic acid heptadecyl, (meth)acrylic acid octadecyl, (meth)acrylic acid isooctadecyl, (meth)acrylic acid nonadecyl, and (meth)acrylic acid eicosyl. Herein, the (meth)acrylic acid alkyl ester means an acrylic acid alkyl ester and/or a methacrylic acid alkyl ester, and all of the “(meth) . . . ” expressions have the same meaning.

For the purpose of modifying cohesive force, heat resistance, and cross-linking property, etc., the acrylic polymer may contain, if necessary, another monomer component (copolymerizable monomer) that is copolymerizable with the (meth)acrylic acid alkyl ester. Accordingly, the acrylic polymer may contain a copolymerizable monomer along with the (meth)acrylic acid alkyl ester as a major component. A monomer having a polar group can be preferably used as the copolymerizable monomer.

Specific examples of the copolymerizable monomer include: carboxyl group-containing monomers, such as acrylic acid, methacrylic acid, carboxy ethyl acrylate, carboxypentyl acrylate, itaconic acid, maleic acid, fumaric acid, crotonic acid, and isocrotonic acid; hydroxyl group-containing monomers, such as (meth)acrylic acid hydroxyalkyls including (meth)acrylic acid 2-hydroxyethyl, (meth)acrylic acid 2-hydroxypropyl, (meth)acrylic acid 3-hydroxypropyl, (meth)acrylic acid 2-hydroxybutyl, (meth)acrylic acid 4-hydroxybutyl, (meth)acrylic acid 6-hydroxyhexyl, (meth)acrylic acid 8-hydroxyoctyl, (meth)acrylic acid 10-hydroxydecyl, (meth)acrylic acid 12-hydroxy lauryl, and (4-hydroxymethyl cyclohexyl) methyl methacrylate; acid anhydride group-containing monomers, such as maleic acid anhydride and itaconic acid anhydride; sulfonic group-containing monomers, such as styrenesulfonic acid, allylsulfonic acid, 2-(meth)acrylamide-2-methylpropanesulfonic acid, (meth)acrylamide propanesulfonic acid, sulfopropyl(meth)acrylate, and (meth)acryloyloxy naphthalenesulfonic acid; phosphate group-containing monomers, such as 2-hydroxyethyl acryloyl phosphate; (N-substituted)amide monomers, such as (meth)acrylamide, N,N-dialkyl(meth)acrylamides including N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide, and N,N-di(t-butyl)(meth)acrylamide, etc., N-isopropyl(meth)acrylamide, N-butyl(meth)acrylamide, N-n-butyl(meth)acrylamide, N-methylol(meth)acrylamide, N-ethylol(meth)acrylamide, N-methylol propane (meth)acrylamide, N-methoxymethyl(meth)acrylamide, N-methoxyethyl(meth)acrylamide, N-butoxymethyl(meth)acrylamide, and N-acryloyl morpholine; succinimide monomers, such as N-(meth)acryloyloxy methylene succinimide, N-(meth)acryloyl-6-oxy hexamethylene succinimide, and N-(meth)acryloyl-8-oxy hexamethylene succinimide; maleimide monomers, such as N-cyclohexyl maleimide, N-isopropylmaleimide, N-lauryl maleimide, and N-phenyl maleimide; itaconimide monomers, such as N-methylitaconimide, N-ethylitaconimide, N-butylitaconimide, N-octylitaconimide, N-2-ethylhexylitaconimide, N-cyclohexylitaconimide, and N-laurylitaconimide; vinyl esters, such as vinyl acetate and vinyl propionate; nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloyl pyrrolidine, N-vinyl morpholine, N-vinyl-2-piperidone, N-vinyl-3-morpholinone, N-vinyl-2-caprolactam, N-vinyl-1,3-oxazine-2-one, N-vinyl-3,5-morpholinedione, N-vinyl pyrazole, N-vinyl isoxazole, N-vinyl thiazole, N-vinyl isothiazole, and N-vinyl pyridazine; N-vinyl carboxylic acid amides; lactam monomers, such as N-vinyl caprolactam; cyano-containing monomers, such as acrylonitrile and methacrylonitrile; (meth)acrylic acid aminoalkyl monomers, such as (meth)acrylic acid aminoethyl, (meth)acrylic acid N,N-dimethylaminoethyl, and (meth)acrylic acid t-butylaminoethyl; (meth)acrylic acid alkoxy alkyl monomers, such as (meth)acrylic acid methoxyethyl, (meth)acrylic acid ethoxyethyl, (meth)acrylic acid propoxyethyl, (meth)acrylic acid butoxyethyl, and (meth)acrylic acid ethoxypropyl; styrene monomers, such as styrene and α-methylstyrene; epoxy group-containing acrylic monomers, such as (meth)acrylic acid glycidyl; acrylic acid ester monomers having a heterocycle, halogen atom, silicon atom, or the like, such as (meth)acrylic acid tetrahydrofurfuryl, fluorine atom-containing (meth)acrylate, and silicone(meth)acrylate; vinyl ether monomers, such as methyl vinyl ether and ethyl vinyl ether; vinyl esters, such as vinyl acetate and vinyl propionate; aromatic vinyl compounds, such as vinyl toluene and styrene; olefins or dienes, such as ethylene, butadiene, isoprene, and isobutylene; vinyl ethers, such as vinyl alkyl ether; vinyl chloride; sulfonic acid group-containing monomers, such as vinyl sulfonate sodium; imide group-containing monomers, such as cyclohexyl maleimide and isopropyl maleimide; isocyanate group-containing monomers, such as 2-isocyanate ethyl(meth)acrylate; acryloyl morpholine; (meth)acrylic acid esters having an alicyclic hydrocarbon group, such as cyclopentyl(meth)acrylate, cyclohexyl(meth)acrylate, isobornyl(meth)acrylate, and dicyclopentenyl(meth)acrylate; (meth)acrylic acid esters having an aromatic hydrocarbon group, such as phenyl(meth)acrylate, and phenoxyethyl(meth)acrylate; and (meth)acrylic acid esters obtained from terpene compound derivative alcohols, etc. These copolymerizable monomers can be used alone or in combination of two or more thereof.

In the pressure-sensitive adhesive composition of the aforementioned aspect, it is preferable that the acrylic polymer contains, as a monomer unit, at least one monomer selected from the group consisting of N-vinyl cyclic amides represented by the following general formula (M1) and hydroxyl group-containing monomers. It is particularly preferable to use a monomer selected from the group consisting of the N-vinyl cyclic amides.

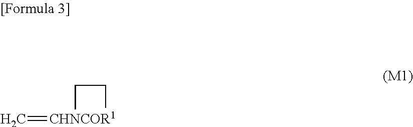

wherein R¹ is a divalent organic group.

Specific examples of the N-vinyl cyclic amides include N-vinyl-2-pyrrolidone, N-vinyl-2-piperidone, N-vinyl-3-morpholinone, N-vinyl-2-caprolactam, N-vinyl-1,3-oxazine-2-one, and N-vinyl-3,5-morpholinedione, etc. Among them, N-vinyl-2-pyrrolidone and N-vinyl-2-caprolactam are particularly preferred.

As specific examples of the hydroxyl group-containing monomers, (meth)acrylic acid 2-hydroxyethyl, (meth)acrylic acid 4-hydroxybutyl, and (meth)acrylic acid 6-hydroxyhexyl, etc., can be preferably used.

The use amount of the copolymerizable monomer is not particularly limited, but the copolymerizable monomer can be contained in an amount usually within a range of 0.01% by mass to 40% by mass, preferably 0.1% by mass to 30% by mass, and more preferably 0.5% by mass to 20% by mass, based on the total mass of the monomer components for preparing the acrylic polymer.

By containing 0.01% by mass or more of the copolymerizable monomer, it can be prevented that the cohesive force of the pressure-sensitive adhesive sheet having a pressure-sensitive adhesive layer formed by the acrylic pressure-sensitive adhesive composition may be decreased. Further, by containing 40% by mass or less of the copolymerizable monomer, it can be prevented that the cohesive force thereof may become too large, and the tackiness at normal temperature (25° C.) can be improved.

In the present embodiment, when the pressure-sensitive adhesive sheet is used in an adherend made of a metal or an adherend, on the surface of which a film made of a metal is formed (e.g., a touch panel, etc., on the surface of which a conductive film (ITO) is formed), it is desirable that a carboxyl group is not contained in the acrylic polymer. Also, from the viewpoint of corrosiveness, it is desirable that acidic functional groups, other than a carboxyl group, are not substantially contained therein. Accordingly, the monomer units for forming the acrylic polymer according to the present invention sometimes do not substantially include a monomer having a carboxyl group or an acidic functional group other than a carboxyl group.

The acidic functional group means a functional group having active hydrogen. Examples of the acidic functional group include, for example, a carboxyl group, sulfonic group, phosphate group, etc. The expression of acidic functional groups “are not substantially contained” means that they are not actively combined, except the case where they are inevitably mixed. Specifically, it is meant that the ratio (% by mass) of a monomer having an acidic functional group to the total mass of units for forming the acrylic polymer is less than 1% by mass, and preferably less than 0.5% by mass.

In addition, the acrylic polymer may contain, if necessary, a polyfunctional monomer for adjusting the cohesive force of the pressure-sensitive adhesive composition to be formed.

Examples of the polyfunctional monomer include, for example:(poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, 1,2-ethylene glycol di(meth)acrylate, 1,6-hexanediol di(meth)acrylate, 1,12-dodecane diol di(meth)acrylate, trimethylolpropane tri(meth)acrylate, tetramethylol methane tri(meth)acrylate, allyl(meth)acrylate, vinyl(meth)acrylate, divinylbenzene, epoxy acrylate, polyester acrylate, urethane acrylate, butyldiol (meth)acrylate, and hexyldiol (meth)acrylate, etc. Among them, trimethylolpropane tri(meth)acrylate, hexanediol di(meth)acrylate, and dipentaerythritol hexa(meth)acrylate can be preferably used. The polyfunctional(meth)acrylates can be used alone or in combination of two or more thereof.

The use amount of the polyfunctional monomer is changed depending on the molecular weight or the number of functional groups thereof, but the polyfunctional monomer is added in an amount within a range of 0.01% by mass to 3.0% by mass, preferably within a range of 0.02% by mass to 2.0% by mass, and more preferably within a range of 0.03% by mass to 1.0% by mass, based on the total mass of the monomer components for preparing the acrylic polymer.

If the use amount of the polyfunctional monomer is more than 3.0% by mass based on the total mass of the monomer components for preparing the acrylic polymer, for example, the cohesive force of the pressure-sensitive adhesive composition may become too large, and accordingly the effect of suppressing the pressure-sensitive adhesive force in the early stage is sometimes decreased. On the other hand, if the use amount is less than 0.01% by mass, for example, the cohesive force of the pressure-sensitive adhesive composition may be decreased, and accordingly the increase in the pressure-sensitive adhesive force, occurring over time, is sometimes insufficient.

In preparing the acrylic polymer, the acrylic polymer can be easily formed by a curing reaction using heat or ultraviolet rays with the use of a polymerization initiator, such as a thermal polymerization initiator, photo-polymerization initiator (photo-initiator), or the like. In particular, photo-polymerization can be preferably used from the advantage that the pressure-sensitive adhesive property is improved, etc. The polymerization initiators can be used alone or in combination of two or more thereof.

Examples of the thermal polymerization initiator include, for example: azo polymerization initiators (for example, 2,2′-azobisisobutyronitrile, 2,2′-azobis-2-methylbutyronitrile, 2,2′-azobis(2-methylpropionic acid)dimethyl, 4,4′-azobis-4-cyanovalerianic acid, azobis isovaleronitrile, 2,2′-azobis(2-amidinopropane)dihydrochloride, 2,2′-azobis[2-(5-methyl-2-imidazoline-2-yl) propane]dihydrochloride, 2,2′-azobis(2-methylpropionamidine)disulfate, and 2,2′-azobis (N,N′-dimethyleneisobutylamidine)dihydrochloride, etc.);peroxide polymerization initiators (for example, dibenzoyl peroxide, t-butyl permaleate, and lauroyl peroxide, etc.); and redox polymerization initiators, etc.

The use amount of the thermal polymerization initiator is not particularly limited, but the thermal polymerization initiator is combined, for example, in an amount within a range of 0.01 parts by mass to 5 parts by mass, and preferably within a range of 0.05 parts by mass to 3 parts by mass, based on 100 parts by mass of the monomer components for preparing the acrylic polymer.

The photo-polymerization initiator is not particularly limited, but, for example, a benzoin ether photo-polymerization initiator, acetophenone photo-polymerization initiator, α-ketol photo-polymerization initiator, aromatic sulfonyl chloride photo-polymerization initiator, photoactive oxime photo-polymerization initiator, benzoin photo-polymerization initiator, benzyl photo-polymerization initiator, benzophenone photo-polymerization initiator, ketal photo-polymerization initiator, thioxanthone photo-polymerization initiator, acylphosphine oxide photo-polymerization initiator, or the like, can be used.

Specific examples of the benzoin ether photo-polymerization initiator include, for example: benzoin methyl ether, benzoin ethyl ether, benzoin propyl ether, benzoin isopropyl ether, benzoin isobutyl ether, 2,2-dimethoxy-1,2-diphenylethane-1-one [product name: IRGACURE 651, made by BASF], and anisoin, etc. Specific examples of the acetophenone photo-polymerization initiator include, for example: 1-hydroxycyclohexyl phenyl ketone [product name: IRGACURE 184, made by BASF], 4-phenoxy dichloroacetophenone, 4-t-butyl-dichloroacetophenone, 1-[4-(2-hydroxyethoxy)-phenyl]-2-hydroxy-2-methyl-1-propane-1-one [product name: IRGACURE 2959, made by BASF], 2-hydroxy-2-methyl-1-phenyl-propane-1-one [product name: DAROCUR 1173, made by BASF], and methoxy acetophenone, etc. Specific examples of the α-ketol photo-polymerization initiator include, for example: 2-methyl-2-hydroxy propiophenone and 1-[4-(2-hydroxyethyl)-phenyl]-2-hydroxy-2-methylpropane-1-one, etc. Specific examples of the aromatic sulfonyl chloride photo-polymerization initiator include, for example, 2-naphthalene sulfonyl chloride, etc. Specific examples of the photoactive oxime photo-polymerization initiator include, for example, 1-phenyl-1,2-propanedione-2-(O-ethoxycarbonyl)-oxime, etc.

Specific examples of the benzoin photo-polymerization initiator include, for example, benzoin, etc. Specific examples of the benzyl photo-polymerization initiator include, for example, benzyl, etc. Specific examples of the benzophenone photo-polymerization initiators include, for example, benzophenone, benzoylbenzoic acid, 3,3′-dimethyl-4-methoxybenzophenone, polyvinyl benzophenone, and α-hydroxy cyclohexyl phenyl ketone, etc. Specific examples of the ketal photo-polymerization initiator include, for example, benzyl dimethyl ketal, etc. Specific examples of the thioxanthone photo-polymerization initiator include, for example, thioxanthone, 2-chlorothioxanthone, 2-methyl thioxanthone, 2,4-dimethyl thioxanthone, isopropyl thioxanthone, 2,4-dichloro thioxanthone, 2,4-diethyl thioxanthone, isopropyl thioxanthone, 2,4-diisopropyl thioxanthone, and dodecyl thioxanthone, etc.

Examples of the acylphosphine photo-polymerization initiator include, for example: bis(2,6-dimethoxybenzoyl)phenylphosphine oxide, bis(2,6-dimethoxybenzoyl)(2,4,4-trimethylpentyl) phosphine oxide, bis(2,6-dimethoxybenzoyl)-n-butyl phosphine oxide, bis(2,6-dimethoxybenzoyl)-(2-methylpropane-1-yl)phosphine oxide, bis(2,6-dimethoxybenzoyl)-(1-methylpropane-1-yl) phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropane-1-yl)phosphine oxide, bis(2-methoxybenzoyl)(1-methylpropane-1-yl)phosphine oxide, bis(2,6-diethoxybenzoyl)(2-methylpropane-1-yl)phosphine oxide, bis(2,6-diethoxybenzoyl)(1-methylpropane-1-yl) phosphine oxide, bis(2,6-dibutoxybenzoyl)(2-methylpropane-1-yl) phosphine oxide, bis(2,4-dimethoxybenzoyl)(2-methypropane-1-yl) phosphine oxide, bis(2,4,6-trimethylbenzoyl)(2,4-dipentoxyphenyl)phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphin e oxide, bis(2,4,6-trimethyl benzoyl)-2,4-di-n-butoxy phenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide, etc.

The use amount of the photo-polymerization initiator is not particularly limited, but the photo-polymerization initiator is combined, for example, in an amount within a range of 0.01 parts by mass to 5 parts by mass, and preferably within a range of 0.05 parts by mass to 3 parts by mass, based on 100 parts by mass of the monomer components for preparing the acrylic polymer.

If the use amount of the photo-polymerization initiator is less than 0.01 parts by mass, the polymerization reaction is sometimes insufficient. If the use amount thereof is more than 5 parts by mass, an ultraviolet ray sometimes does not reach the inside of the pressure-sensitive adhesive layer, because the photo-polymerization initiator absorbs an ultraviolet ray. In this case, a decrease in the rate of polymerization is caused, or the molecular weight of the generated polymer becomes small. Thereby, the cohesive force of the pressure-sensitive adhesive layer formed may become small, and hence the increase in the pressure-sensitive adhesive force, occurring over time, is sometimes insufficient. The photo-polymerization initiators can be used alone or in combination of two or more thereof.

In the present embodiment, the acrylic polymer (A) can also be prepared as a partial polymer (acrylic polymer syrup) that can be obtained by radiating ultraviolet (UV) rays onto a mixture in which the aforementioned monomer components and the polymerization initiator have been combined, so that the monomer components are partially polymerized. A pressure-sensitive adhesive composition is prepared by combining the later-described (meth)acrylic polymer (B) into the acrylic polymer syrup, and then polymerization can also be completed by coating the pressure-sensitive adhesive composition on a predetermined object to be coated and by radiating UV rays. That is, the acrylic polymer syrup is a precursor of the polymer (A), and the combined material in which the (meth)acrylic polymer (B) has been combined into the acrylic polymer syrup is also included in the pressure-sensitive adhesive composition according to the present invention.

### [(Meth)acrylic Polymer (B)]

The (meth)acrylic polymer (B) is a (meth)acrylic polymer having a weight average molecular weight (MwB) of 1000≦MwB<30000 that contains, as monomer units, both a (meth)acrylic monomer having an alicyclic structure represented by the following general formula (1) and a monomer having a polyoxyalkylene skeleton, the (meth)acrylic polymer (B) functioning as an additive for adjusting pressure-sensitive adhesive force in a pressure-sensitive adhesive composition.

CH₂═C(R¹)COOR² (1)

[wherein R¹ represents a hydrogen atom or a methyl group and R² represents an alicyclic hydrocarbon group having an alicyclic structure.]

Examples of the alicyclic hydrocarbon group R² in the general formula (1) include alicyclic hydrocarbon groups, such as a cyclohexyl group, isobornyl group, and dicyclopentanyl group, etc. Examples of the (meth)acrylic monomer having such an alicyclic hydrocarbon group include esters with alicycle alcohols of (meth)acrylic acids, such as, for example, (meth)acrylic acid cyclohexyl having a cyclohexyl group, (meth)acrylic acid isobornyl having an isobornyl group, and (meth)acrylic acid dicyclopentanyl having a dicyclopentanyl group. Thus, by providing, as a monomer unit, a (meth)acrylic monomer having a relatively bulky structure to the (meth)acrylic polymer (B), the pressure-sensitive adhesive force, occurring over time, and the rate of increasing the pressure-sensitive adhesive force can be enhanced.

In addition, it is preferable that the alicyclic hydrocarbon group in the (meth)acrylic monomer having an alicyclic structure that forms the (meth)acrylic polymer (B) has a bridged ring structure. The bridged ring structure refers to an alicyclic structure of three or more rings. By providing a bulkier structure, such as a bridged ring structure, to the (meth)acrylic polymer (B), the adhesiveness of the pressure-sensitive adhesive composition (pressure-sensitive adhesive sheet) can be more improved. Further, the pressure-sensitive adhesive force, occurring over time, and the rate of increasing the pressure-sensitive adhesive force, of the pressure-sensitive adhesive composition (pressure-sensitive adhesive sheet), can be enhanced.

Examples of the R², which is an alicyclic hydrocarbon group having a bridged ring structure, include, for example: a dicyclopentanyl group represented by the following formula (3a); a dicyclopentenyl group represented by the following formula (3b); an adamantyl group represented by the following formula (3c); a tricyclopentanyl group represented by the following formula (3d); and a tricyclopentenyl group represented by the following formula (3e), etc. When UV polymerization is adopted in synthesizing the (meth)acrylic polymer (B) or in producing the pressure-sensitive adhesive composition, a (meth)acrylic monomer having a saturated structure, such as the dicyclopentanyl group represented by the following formula (3a), the adamantyl group represented by the following formula (3c), the tricyclopentanyl group represented by the following formula (3d), or the like, of the (meth)acrylic monomers having an alicyclic structure of three or more rings that has a bridged ring structure, can be particularly and preferably used as a monomer for forming the (meth)acrylic polymer (B), from the viewpoint of hardly causing inhibition of polymerization.

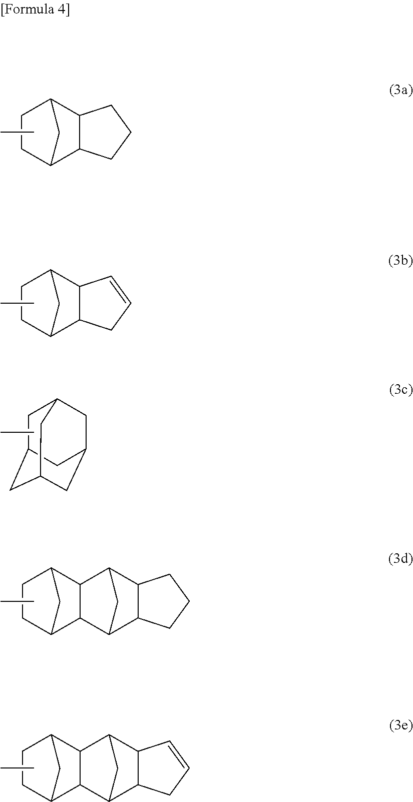

Examples of the (meth)acrylic monomer having an alicyclic structure of three or more rings that has such a bridged ring structure include (meth)acrylic acid esters, such as dicyclopentanyl methacrylate, dicyclopentanyl acrylate, dicyclopentanyl oxyethyl methacrylate, dicyclopentanyl oxyethyl acrylate, tricyclopentanyl methacrylate, tricyclopentanyl acrylate, 1-adamantyl methacrylate, 1-adamantyl acrylate, 2-methyl-2-adamantyl methacrylate, 2-methyl-2-adamantyl acrylate, 2-ethyl-2-adamantyl methacrylate, and 2-ethyl-2-adamantyl acrylate. These (meth)acrylic monomers can be used alone or in combination of two or more thereof.

Examples of the monomer having a polyoxyalkylene skeleton that forms the (meth)acrylic polymer (B) include an oxyalkylene(meth)acrylate adduct, anionic reactive surfactant, nonionic reactive surfactant, and cationic reactive surfactant, etc., each of the last three surfactants having, in its molecule, a reactive substituent, such as an acryloyl group, methacryloyl group, allyl group, or the like. The polyoxyalkylene chain develops a moderate balance between the compatibility and immisibility between the polymer (A) and the (meth)acrylic polymer (B), and hence the suppression of the pressure-sensitive adhesive force, occurring when an adherend is adhered, and the increase in the pressure-sensitive adhesive force, occurring over time, can be appropriately adjusted. In particular, an oxyalkylene group-containing monomer represented by the following general formula (2) can be preferably used.

[Formula 5]

CH₂═C(R₁)—COO—(CₘH₂ₘO)ₙ—(CₚH₂ₚO)_{q}—R₂ (2)

[wherein R₁ represents hydrogen or a methyl group, R₂ represents hydrogen or a monovalent organic group, m and p represent integers of 2 to 4, and n and q represent integers of 0 or 2 to 40 that are not 0 at a time.]

Specific examples of the oxyalkylene group-containing monomer include, for example, methoxy polyethylene glycol(meth)acrylate, ethoxypolyethylene glycol (meth)acrylate, butoxypolyethylene glycol (meth)acrylate, octoxypolyethylene glycol(meth)acrylate, lauroxypolyethylene glycol(meth)acrylate, stearoxypolyethylene glycol (meth)acrylate, phenoxypolyethylene glycol (meth)acrylate, phenoxypolyethylene glycol-polypropylene glycol(meth)acrylate, methoxypolypropylene glycol(meth)acrylate, nonylphenoxypolypropylene glycol(meth)acrylate, nonylphenoxypolyethylene glycol(meth)acrylate, nonylphenoxyethylene glycol-polypropylene glycol (meth)acrylate, and octoxypolyethylene glycol-polypropylene glycol(meth)acrylate, etc. These oxyalkylene group-containing monomers can be used alone or in combination of two or more thereof.

Among them, an oxyalkylene group-containing monomer in which the average added mole number of the oxyalkylene unit (the total of n and q in the above general formula (2)) is 3 to 40 is preferred from the viewpoint of a balance between the compatibility with the polymer (A) and the adhesion reliability as a pressure-sensitive adhesive composition.

Specific examples of commercial products of the oxyalkylene group-containing monomer include, for example, BLEMMERPME-400, BLEMMERPME-1000, BLEMMER50POEP-800B (these are made by NOF CORPORATON), LAMUTEL PD-420, LAMUTEL PD-430 (these are made by Kao Corporation), Adekaria Soap ER-10, and Adekaria Soap NE-10 (these are made by ADEKA CORPORATION), etc.

Specific examples of the reactive surfactants include an anionic reactive surfactant, nonionic reactive surfactant, and cationic reactive surfactant e active agent, each having, for example, a (meth)acryloyl group or an allyl group.

Examples of the anionic reactive surfactant include, for example, surfactants represented by the formulae (A1) to (A10).

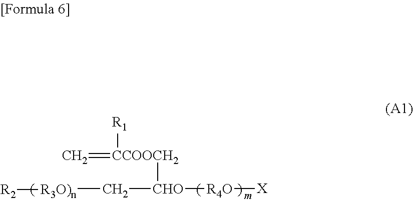

[wherein R₁ represents hydrogen or a methyl group, R₂ represents a C₁₋₃₀ hydrocarbon group or acyl group, X represents an anionic hydrophilic group, R₃ and R₄ may be the same or different and represent C₁₋₆ alkylene groups, and average added mole numbers m and n represent integers of 0 to 40, however (m+n) represents an integer of 3 to 40.]

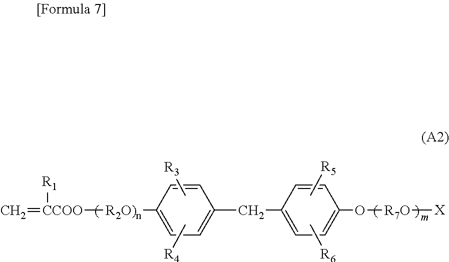

[wherein R₁ represents hydrogen or a methyl group, R₂ and R₂ may be the same or different and represent C₁₋₆ alkylene groups, R₃ and R₅ may be the same or different and represent hydrogen or alkyl groups, R₄ and R₆ may be the same or different and represent hydrogen, alkyl groups, benzyl groups, or styrene groups, X represents an anionic hydrophilic group, and average added mole numbers m and n represent integers of 0 to 40, however (m+n) represents an integer of 3 to 40.]

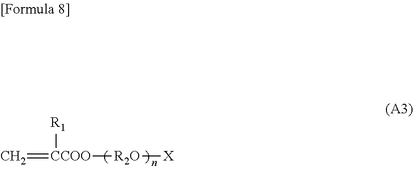

[wherein R₁ represents hydrogen or a methyl group, R₂ represents a C₁₋₆ alkylene group, X represents an anionic hydrophilic group, and average added mole number n represents an integer of 3 to 40.]

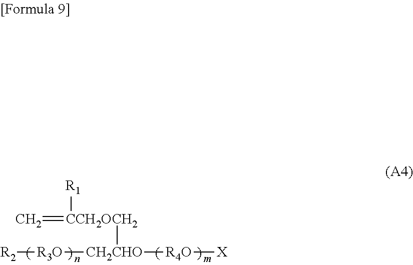

[wherein R₁ represents hydrogen or a methyl group, R₂ represents a C₁₋₃₀ hydrocarbon group or acyl group, R₃ and R₄ may be the same or different and represent C₁₋₆ alkylene groups, X represents an anionic hydrophilic group, and average added mole numbers m and n represent integers of 0 to 40, however (m+n) represents an integer of 3 to 40.]

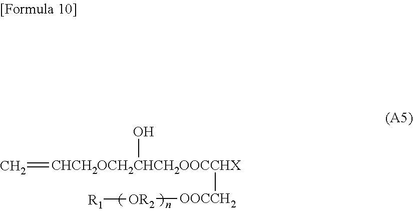

[wherein R₁ represents a hydrocarbon group, amino group or carboxylate residue, R₂ represents a C₁₋₆ alkylene group, X represents an anionic hydrophilic group, and average added mole number n represents an integer of 3 to 40.]

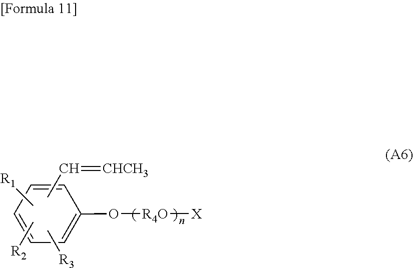

[wherein R₁ represents a C₁₋₃₀ hydrocarbon group, R₂ represents a C₁₋₃₀ hydrogen group, R₃ represents hydrogen or a propenyl group, R₄ represents a C₁₋₆ alkylene group, X represents an anionic hydrophilic group, and average added mole number n represents an integer of 3 to 40.]

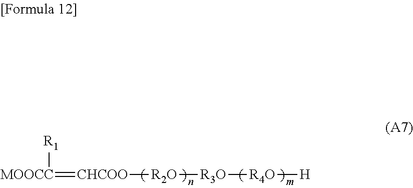

[wherein R₁ represents hydrogen or a methyl group, R₂ and R₄ may be the same or different and represent C₁₋₆ alkylene groups, R₃ represents a C₁₋₃₀ hydrocarbon group, M represents hydrogen, an alkali metal, ammonium group, or alkanol ammonium group, and average added mole numbers m and n represent integers of 0 to 40, however (m+n) represents an integer of 3 to 40.]

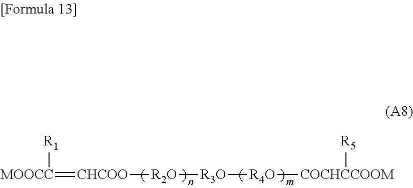

[wherein R₁ and R₅ may be the same or different and represent hydrogen or methyl groups, R₂ and R₄ may be the same or different and represent C₁₋₆ alkylene groups, R₃ represents a C₁₋₃₀ hydrocarbon group, M represents hydrogen, an alkali metal, ammonium group, or alkanol ammonium group, average added mole numbers m and n represent integers of 0 to 40, however (m+n) represents an integer of 3 to 40.]

[Formula 14]

MOOCCH═CHCOOR₁OₙR₂ (A9)

[wherein R₁ represents a C₁₋₆ alkylene group, R₂ represents a C₁₋₃₀ hydrocarbon group, M represents hydrogen, an alkali metal, ammonium group, or alkanol ammonium group, and average added mole number n represents an integer of 3 to 40.]

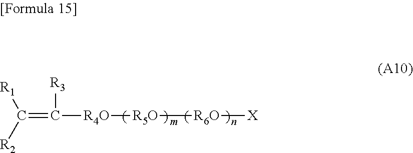

[wherein R₁, R₂, and R₃ may be the same or different and represent hydrogen or methyl groups, R₄ represents a C₀₋₃₀ hydrocarbon group (the case where the number of carbons is 0 means that R₄ is not present), R₅ and R₆ may be the same or different and represent C₁₋₆ alkylene groups, X represents an anionic hydrophilic group, and average added mole numbers m and n represent integers of 0 to 40, however (m+n) represents an integer of 3 to 40.]

The X in the above formulae (A1) to (A6) and (A10) represents an anionic hydrophilic group. Examples of the anionic hydrophilic group include ones represented by the following formulae (a1) and (a2).

[Formula 16]

SO₃M₁ (a1)

[wherein M₁ represents hydrogen, an alkali metal, ammonium group, or alkanol ammonium group.]

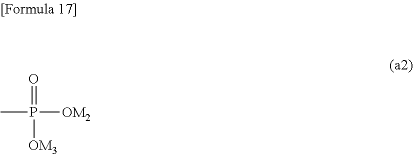

[wherein M₂ and M₃ may be the same or different and represent hydrogen, alkali metals, ammonium groups, or alkanol ammonium groups.]

Examples of the nonionic reactive surfactant include, for example, ones represented by the formulae (N1) to (N6).

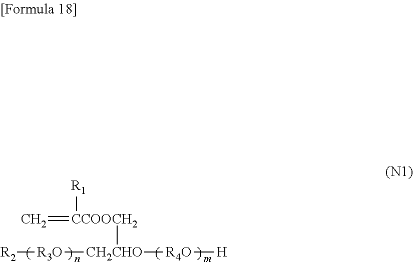

[wherein R₁ represents hydrogen or a methyl group, R₂ represents a C₁₋₃₀ hydrocarbon group or acyl group, R₃ and R₄ may be the same or different and represent C₁₋₆ alkylene groups, and average added mole numbers m and n represent integers of 0 to 40, however (m+n) represents an integer of 3 to 40.]

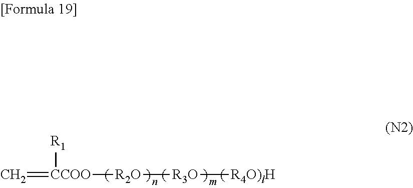

[wherein R₁ represents hydrogen or a methyl group, R₂, R₃, and R₄ may be the same or different and represent C₁₋₆ alkylene groups, and average added mole numbers n and m integers of 0 to 40 and (n+m+l) is an integer of 3 to 40.]

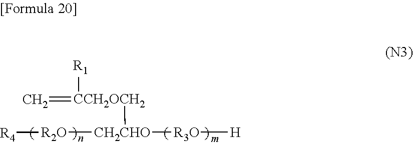

[wherein R₁ represents hydrogen or a methyl group, R₂ and R₃ may be the same or different and represent C₁₋₆ alkylene groups, R₄ represents a C₁₋₃₀ hydrocarbon group or acyl group, and average added mole numbers m and n represent integers of 0 to 40, however (m+n) represents an integer of 3 to 40.]

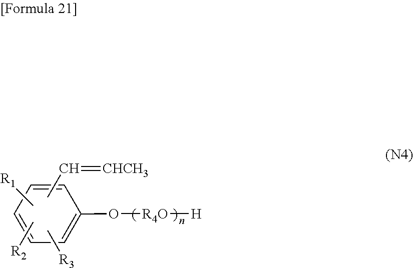

[wherein R₁ and R₂ may be the same or different and represent C₁₋₃₀ hydrocarbon groups, R₃ represents hydrogen or a propenyl group, R₄ represents a C₁₋₆ alkylene group, and average added mole number n represents an integer of 3 to 40.]

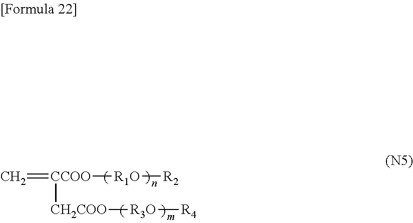

[wherein R1 and R3 may be the same or different and represent C₁₋₆ alkylene groups, R2 and R4 may be the same or different and represent hydrogen, C1-30 hydrocarbon groups, or acyl groups, and average added mole numbers m and n represent integers of 0 to 40, however (m+n) represents an integer of 3 to 40.]

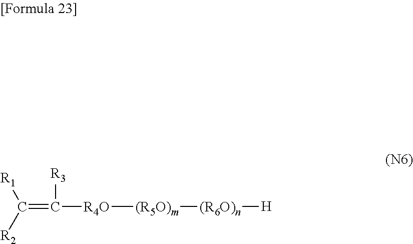

[wherein R₁, R₂, and R₃ may be the same or different and represent hydrogen or methyl groups, R₄ represents a C₀₋₃₀ hydrocarbon group (the case where the number of carbons is 0 means that R₄ is not present), R₅ and R₆ may be the same or different and represent C₁₋₆ alkylene groups, and average added mole numbers m and n represent integers of 0 to 40, however (m+n) represents an integer of 3 to 40.]

The (meth)acrylic polymer (B) may be a copolymer between the (meth)acrylic monomer having an alicyclic structure and the monomer having a polyoxyalkylene skeleton. Alternatively, the polymer (B) may be a copolymer among the (meth)acrylic monomer having an alicyclic structure, the monomer having a polyoxyalkylene skeleton, and another (meth)acrylic acid ester monomer or a copolymerizable monomer.

Examples of such a (meth)acrylic acid ester include: (meth)acrylic acid alkyl esters, such as (meth)acrylic acid methyl, (meth)acrylic acid ethyl, (meth)acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid-2-ethylhexyl,(meth)acrylic acid heptyl, (meth)acrylic acid octyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, and (meth)acrylic acid dodecyl; (meth)acrylic acid aryl esters, such as (meth)acrylic acid phenyl and (meth)acrylic acid benzyl; and (meth)acrylic acid esters obtained from terpene compound derivative alcohols, etc. These (meth)acrylic acid esters can be used alone or in combination of two or more thereof.

Alternatively, the (meth)acrylic polymer (B) can also be obtained by copolymerizing another monomer component (copolymerizable monomer) that is copolymerizable with the (meth)acrylic acid ester, in addition to the aforementioned (meth)acrylic acid ester component unit. For example, a functional group reactive with an epoxy group or an isocyanate group may be further introduced into the (meth)acrylic polymer (B). Examples of such a functional group include a hydroxyl group, carboxyl group, amino group, amide group, and a mercapto group. When the (meth)acrylic polymer (B) is produced, a monomer having such a functional group may be used (copolymerized).

Examples of the another monomer that is copolymerizable with the (meth)acrylic acid ester include: carboxyl group-containing monomers, such as acrylate, methacrylic acid, carboxy ethyl acrylate, carboxypentyl acrylate, itaconic acid, maleic acid, fumaric acid, crotonic acid, and isocrotonic acid; (meth)acrylic acid alkoxy alkyl monomers, such as (meth)acrylic acid methoxyethyl, (meth)acrylic acid ethoxyethyl, (meth)acrylic acid propoxyethyl, (meth)acrylic acid butoxyethyl, and (meth)acrylic acid ethoxypropyl; salts, such as (meth)acrylic acid alkali metal salt; di(meth)acrylic acid ester monomers of (poly)oxyalkylene, such as di(meth)acrylic acid ester of ethylene glycol, di(meth)acrylic acid ester of diethylene glycol, di(meth)acrylic acid ester of triethylene glycol, di(meth)acrylic acid ester of polyethylene glycol, di(meth)acrylic acid ester of propylene glycol, di(meth)acrylic acid ester of dipropylene glycol, and di(meth)acrylic acid ester of tripropylene glycol; poly(meth)acrylic acid ester monomers, such as trimethylolpropane tri(meth)acrylic acid ester; vinyl esters, such as vinyl acetate and vinyl propionate; halogenated vinyl compounds, such as vinylidene chloride and (meth)acrylic acid-2-chloroethyl; oxazoline group-containing polymerizable compounds, such as 2-vinyl-2-oxazoline, 2-vinyl-5-methyl-2-oxazoline, and 2-isopropenyl-2-oxazoline; aziridine group-containing polymerizable compounds, such as (meth)acryloylaziridine and (meth)acrylic acid-2-aziridinylethyl; epoxy group-containing vinyl monomers, such as allyl glycidyl ether, (meth)acrylic acid glycidyl ether, and (meth)acrylic acid-2-ethyl glycidyl ether; hydroxyl group-containing vinyl monomers, such as (meth)acrylic acid-2-hydroxyethyl, (meth)acrylic acid-2-hydroxypropyl, and adducts between lactones and (meth)acrylic acid-2-hydroxyethyl; fluorine-containing vinyl monomers, such as fluorine-substituted (meth)acrylic acid alkyl ester; acid anhydride group-containing monomers, such as maleic acid anhydride and itaconic acid anhydride; aromatic vinyl compound monomers, such as styrene, α-methylstyrene, and vinyl toluene; reactive halogen-containing vinyl monomers, such as 2-chloroethyl vinyl ether and monochloro vinyl acetate; amide group-containing vinyl monomers, such as (meth)acrylamide, N-isopropyl(meth)acrylamide, N-butyl(meth)acrylamide, N,N-diethyl(meth)acrylamide, N,N-dimethyl(meth)acrylamide, N-methylol(meth)acrylamide, N-ethylol(meth)acrylamide, N-methylolpropane(meth)acrylamide, N-methoxyethyl(meth)acrylamide, N-butoxymethyl(meth)acrylamide, and N-acryloyl morpholine; succinimide monomers, such as N-(meth)acryloyloxy methylene succinimide, N-(meth)acryloyl-6-oxy hexamethylene succinimide, and N-(meth)acryloyl-8-oxy hexamethylene succinimide; maleimide monomers, such as N-cyclohexyl maleimide, N-isopropylmaleimide, N-lauryl maleimide, and N-phenyl maleimide; itaconimide monomers, such as N-methylitaconimide, N-ethylitaconimide, N-butylitaconimide, N-octylitaconimide, N-2-ethylhexylitaconimide, N-cyclohexylitaconimide, and N-laurylitaconimide; nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinyl morpholine, N-vinyl pyrazole, N-vinyl isoxazole, N-vinyl thiazole, N-vinyl isothiazole, and N-vinyl pyridazine; N-vinyl carboxylic acid amides; lactam monomers, such as N-vinyl caprolactam; cyanoacrylate monomers, such as (meth)acrylonitrile; (meth)acrylic acid aminoalkyl monomers, such as (meth)acrylic acid aminoethyl, (meth)acrylic acid N,N-dimethylaminoethyl, and (meth)acrylic acid t-butylaminoethyl; imide group-containing monomers, such as cyclohexyl maleimide and isopropyl maleimide; isocyanate group-containing monomers, such as 2-isocyanate ethyl(meth)acrylate; organic silicon-containing vinyl monomers, such as vinyltrimethoxysilane, γ-methacryloxpropyl trimethoxy silane, allyltrimethoxysilane, trimethoxysilylpropylallylamine, and 2-methoxy ethoxy trimethoxy silane; hydroxyl group-containing monomers, such as (meth)acrylic acid hydroxyalkyls including (meth)acrylic acid hydroxyethyl, (meth)acrylic acid hydroxypropyl, (meth)acrylic acid hydroxybutyl, (meth)acrylic acid hydroxyhexyl, (meth)acrylic acid hydroxyoctyl, (meth)acrylic acid hydroxydecyl, (meth)acrylic acid hydroxylauryl, and (4-hydroxymethyl cyclohexyl)methyl methacrylate; acrylic acid ester monomers having a heterocycle, halogen atom, silicon atom, or the like, such as (meth)acrylic acid tetrahydrofurfuryl, fluorine atom-containing (meth)acrylate, and silicone(meth)acrylate; olefin monomers, such as isoprene, butadiene, and isobutylene; vinyl ether monomers, such as methyl vinyl ether and ethyl vinyl ether; olefins or dienes, such as ethylene, butadiene, isoprene, and isobutylene; vinyl ethers, such as vinyl alkyl ether; vinyl chloride; and others, such as macro-monomers having a radically polymerizable vinyl group at the monomer end to which a vinyl group has been polymerized, etc. These monomers can be copolymerized, alone or in combination thereof, with the (meth)acrylic acid esters.

Examples of the (meth)acrylic polymer (B) include, for example, a copolymer between dicyclopentanyl methacrylate (DCPMA) and methoxy polyethylene glycol methacrylate, that between isobornyl methacrylate (IBXMA) and methoxy polyethylene glycol methacrylate, that between cyclohexyl methacrylate (CHMA) and methoxy polyethylene glycol methacrylate, and that among dicyclopentanyl methacrylate (DCPMA), methyl methacrylate (MMA), and methoxy polyethylene glycol methacrylate, etc.

When the (meth)acrylic polymer (B) is a copolymer among the (meth)acrylic monomer having an alicyclic structure, the monomer having a polyoxyalkylene skeleton, and another (meth)acrylic acid ester monomer or a copolymerizable monomer, the content ratio of the (meth)acrylic monomer having an alicyclic structure is 5% by mass or more, preferably 7% by mass or more, and more preferably 10% by mass or more (usually less than 70% by mass, preferably 40% by mass or less, and more preferably 20% by mass or less), in the whole monomers that form the (meth)acrylic polymer (B). By containing the (meth)acrylic monomer having an alicyclic structure in an amount of 5% by mass or more, the pressure-sensitive adhesive force, occurring over time, and the rate of increasing the pressure-sensitive adhesive force can be enhanced, without deteriorating the transparency. If the content ratio is less than 5% by mass, the pressure-sensitive adhesive force, occurring over time, or the rate of increasing the pressure-sensitive adhesive force is sometimes deteriorated.

When the (meth)acrylic polymer (B) is a copolymer among the (meth)acrylic monomer having an alicyclic structure, the monomer having a polyoxyalkylene skeleton, and another (meth)acrylic acid ester monomer or a copolymerizable monomer, the content ratio of the monomer having a polyoxyalkylene skeleton is 30% by mass or more, preferably 45% by mass or more, more preferably 60% by mass or more, and still more preferably 80% by mass or more (usually less than 95% by mass, and preferably 90% by mass or less), in the whole monomers that form the (meth)acrylic polymer (B). By containing the monomer having a polyoxyalkylene skeleton in an amount of 30% by mass or more, the suppression of the pressure-sensitive adhesive force, occurring when an adherend is attached, and the increase in the pressure-sensitive adhesive force, occurring over time, can be appropriately adjusted, without deteriorating the transparency. If the content ratio is less than 30% by mass, the adhesiveness, in particular, the effect of suppressing the pressure-sensitive adhesive force, occurring when an adherend is attached, sometimes becomes insufficient.

The weight average molecular weight (MwB) of the (meth)acrylic polymer (B) is 1000≦MwB<30000, preferably 1500≦MwB<20000, and more preferably 2000≦MwB<10000. If the weight average molecular weight is 30000 or more, the compatibility with the polymer may be deteriorated, and accordingly the effect of increasing the pressure-sensitive adhesive force, occurring over time, is not sometimes obtained. On the other hand, if the weight average molecular weight is less than 1000, it becomes too small, and hence the pressure-sensitive adhesive force and the rate of increasing the force, occurring over time, are sometimes deteriorated.

The weight average molecular weights of the polymer (A) and the (meth)acrylic polymer (B) can be determined by polystyrene conversion using gel permeation chromatography (GPC). Specifically, the measurement of the weight average molecular weight is performed in accordance with the method and conditions described in the later-described Examples.

The (meth)acrylic polymer (B) can be produced by polymerizing a (meth)acrylic monomer having the aforementioned structure with the use of a solution polymerization method, bulk polymerization method, emulsion polymerization method, suspension polymerization, and block polymerization, etc.

In order to adjust the molecular weight of the (meth)acrylic polymer (B), a chain transfer agent can be used while the polymer (B) is being polymerized. Examples of the chain transfer agent to be used include: compounds having a mercapt group, such as octylmercaptan, laurylmercaptan, t-nonyl mercaptan, t-dodecyl mercaptan, and mercaptoethanol; thioglycolic acid, methyl thioglycolate, ethyl thioglycolate, propyl thioglycolate, butyl thioglycolate, t-butyl thioglycolate, 2-ethylhexylthioglycolate, octyl thioglycolate, isooctyl thioglycolate, decyl thioglycolate, dodecyl thioglycolate, and thioglycolic acid esters including thioglycolic acid ester of ethylene glycol, thioglycolic acid ester of neopentyl glycol, and thioglycolic acid ester of pentaerythritol; and α-methylstyrene dimer, etc.

The use amount of the chain transfer agent is not particularly limited, but the chain transfer agent is usually contained in an amount within a range of 0.1 parts by mass to 20 parts by mass, preferably within a range of 0.2 parts by mass to 15 parts by mass, and more preferably within a range of 0.3 parts by mass to 10 parts by mass, based on 100 parts by mass of the (meth)acrylic monomer. By adjusting the addition amount of the chain transfer agent in this way, the (meth)acrylic polymer (B) having a preferred molecular weight can be obtained. The chain transfer agents can be used alone or in combination of two or more thereof.

### [Pressure-Sensitive Adhesive Composition]

The pressure-sensitive adhesive composition comprises, as essential components, the aforementioned polymer (A) and the (meth)acrylic polymer (B). Although the content of the (meth)acrylic polymer (B) is 0.05 parts by mass to 20 parts by mass based on 100 parts by mass of the polymer (A), it is preferably 0.08 parts by mass to 15 parts by mass, and more preferably 0.1 parts by mass to 10 parts by mass. In the pressure-sensitive adhesive composition according to the present embodiment, it can be considered that: by introducing a polyoxyalkylene skeleton into the (meth)acrylic polymer (B), the polymer (B) is present on the interface immediately after being attached, so that the polymer (B) acts so as to reduce the pressure-sensitive adhesive force in the early stage; on the other hand, by introducing an alicyclic structure, the adhesive force of the interface becomes large, which contributes to the increase in the pressure-sensitive adhesive force. If the (meth)acrylic polymer (B) is added in an amount more than 20 parts by mass, the transparency of the pressure-sensitive adhesive layer formed by the pressure-sensitive adhesive composition according to the present embodiment is deteriorated. If the (meth)acrylic polymer (B) is added in an amount less than 0.05 parts by mass, the effect of suppressing the pressure-sensitive adhesive force, occurring when an adherend is attached, is poor, and hence a trouble in which rework cannot be performed sometimes occur.

Other than the aforementioned polymer (A) and the (meth)acrylic polymer (B), the pressure-sensitive adhesive composition may comprise, as optional components, various additives that are typical in the field of pressure-sensitive adhesive compositions. Such optional components are exemplified by a tackifying resin, cross-linking agent, catalyst, plasticizer, softener, filler, colorant (pigment, dye, or the like), antioxidant, leveling agent, stabilizer, antiseptic, and antistatic agent, etc. Such additives that are conventionally- and publicly-known can be used by ordinary methods.

In order to adjust the cohesive force of the later-described pressure-sensitive adhesive layer, a cross-linking agent can also be used, other than the aforementioned polyfunctional monomers. Cross-linking agents that are ordinarily used can be used as the cross-linking agent. Examples of the cross-linking agent include, for example: an epoxy cross-linking agent, isocyanate cross-linking agent, silicone cross-linking agent, oxazoline cross-linking agent, aziridine cross-linking agent, silane cross-linking gent, alkyl-etherified melamine cross-linking agent, and metal chelate cross-linking agent, etc. In particular, an isocyanate cross-linking agent, epoxy cross-linking agent, and metal chelate cross-linking agent can be preferably used. These compounds may be used alone or in combination of two or more thereof.

Specific examples of the isocyanate cross-linking agent include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethyl xylylene diisocyanate, naphthalene diisocyanate, triphenylmethane triisocyanate, polymethylene polyphenyl isocyanate, and these adducts with polyols, such as trimethylolpropane. Alternatively, a compound having, in one molecule, at least one isocyanate group and one or more unsaturated bonds, specifically 2-isocyanate ethyl(meth)acrylate, etc., can also be used as the isocyanate cross-linking agent. These compounds may be used alone or in combination of two or more thereof.

Examples of the epoxy cross-linking agent include bisphenol A, epichlorohydrin type epoxy resin, ethyleneglycidylether, polyethylene glycol diglycidyl ether, glycerin diglycidyl ether, glycerin triglycidyl ether, 1,6-hexanediol glycidyl ether, trimethylolpropane triglycidyl ether, diglycidyl aniline, diamine glycidyl amine, N,N,N′,N′-tetraglycidyl-m-xylylenediamine, and 1,3-bis(N,N-diglycidyl aminomethyl)cyclohexane, etc. These compounds may be used alone or in combination of two or more thereof.

Examples of the metal chelate compound include: as metal components, aluminum, iron, tin, titanium, and nickel; and as chelate components, acetylene, methyl acetoacetate, and ethyl lactate, etc. These compounds may be used alone or in combination of two or more thereof.

The cross-linking agent is preferably contained in an amount of 0.01 parts by mass to 15 parts by mass, and more preferably contained in an amount of 0.5 parts by mass to 10 parts by mass, based on 100 parts by mass of the polymer (A). If the content thereof is less than 0.01 parts by mass, the cohesive force of the pressure-sensitive adhesive composition may become small, and hence the adhesion reliability is sometimes deteriorated. On the other hand, if the content is more than 15 parts by mass, the cohesive force of the pressure-sensitive adhesive composition may become large and the flow property of the pressure-sensitive adhesive may become poor, and hence the increase in the pressure-sensitive adhesive force, occurring over time, is sometimes deteriorated.

The pressure-sensitive adhesive composition disclosed herein may further comprise a cross-linking catalyst for effectively promoting one of the aforementioned cross-linking reactions. As such a cross-linking catalyst, for example, a tin catalyst (in particular, dioctyl tin dilaurate) can be preferably used. The use amount of the cross-linking catalyst (e.g., a tin catalyst, such as dioctyl tin dilaurate) is not particularly limited, but it may be, for example, approximately 0.0001 parts by mass to 1 part by mass based on 100 parts by mass of the polymer (A).

### [Pressure-Sensitive Adhesive Layer and Pressure-Sensitive Adhesive Sheet]

Subsequently, the structure of a pressure-sensitive adhesive sheet, having a pressure-sensitive adhesive layer containing the aforementioned pressure-sensitive adhesive composition, will be described.

The pressure-sensitive adhesive layer can be a layer in which the acrylic pressure-sensitive adhesive composition has been cured. That is, the pressure-sensitive adhesive layer can be formed by providing the acrylic pressure-sensitive adhesive composition to an appropriate substrate (e.g., coating) and then by appropriately subjecting the composition to a curing treatment. When two or more types of curing treatments (drying, cross-link formation, polymerization, etc.) are performed, these treatments can be performed simultaneously or in multiple stages. In the case of the pressure-sensitive adhesive composition in which a partial polymer (acrylic polymer syrup) has been used, a final copolymerization reaction is typically performed as the curing treatment (the partial polymer is subjected to a further copolymerization reaction to form a complete polymer). For example, in the case of a photo-curing pressure-sensitive adhesive composition, light radiation is performed. A curing treatment, such as cross-link formation, drying, or the like, may be performed, if necessary. For example, when a photo-curing pressure-sensitive adhesive composition needs to be dried, light radiation may be performed after the drying of the composition. In the case of the pressure-sensitive adhesive composition in which a complete polymer has been used, a treatment, such as drying (drying by heating), cross-link formation, or the like, is typically performed as the curing treatment, if necessary.

The coating of the pressure-sensitive adhesive composition can be performed by using a commonly-used coater, such as, for example, a gravure roll coater, reverse roll coater, kiss roll coater, dip roll coater, bar coater, knife coater, spray coater, or the like. Alternatively, the pressure-sensitive adhesive layer may be formed by directly providing the pressure-sensitive adhesive composition to a substrate, or the pressure-sensitive adhesive layer formed on a release liner may be transferred to a substrate.

It is desirable that the ratio of the solvent-insoluble component in the pressure-sensitive adhesive layer is within a range of 55.0% by mass to 99.0% by mass, and preferably within a range of 60.0% by mass to 95.0% by mass. If the ratio of the solvent-insoluble component is less than 55.0% by mass, the cohesive force may become insufficient, and hence the adhesion reliability is sometimes deteriorated. On the other hand, if the rate thereof is more than 99.0% by mass, the cohesive force may become too large, and hence the increase in the pressure-sensitive adhesive force, occurring over time, sometimes becomes insufficient. A method of evaluating the ratio of the solvent-insoluble component will be described later.

The thickness of the pressure-sensitive adhesive layer is not particularly limited, but is usually within a range of 3 μm to 200 μm, and preferably within a range of 5 μm to 150 μm. By setting the thickness to be within such a range, good adhesiveness can be achieved. If the thickness thereof is smaller than 3 μm, the increase in the pressure-sensitive adhesive force, occurring over time, is sometimes deteriorated. On the other hand, if the thickness thereof is larger than 200 μm, the effect of suppressing the pressure-sensitive adhesive force, occurring immediately after being attached, sometimes becomes insufficient.

The pressure-sensitive adhesive sheet according to the present embodiment comprises a pressure-sensitive adhesive layer made of the pressure-sensitive adhesive composition. In the pressure-sensitive adhesive sheet, such a pressure-sensitive adhesive layer is provided on at least one surface of a substrate in a fixed manner, i.e., without an intention of separating the pressure-sensitive adhesive layer from the substrate. The concept of the pressure-sensitive adhesive sheet described herein can involve objects referred to as a pressure-sensitive adhesive tape, a pressure-sensitive adhesive film, and a pressure-sensitive adhesive label, etc. The pressure-sensitive adhesive sheet may be one that is cut or subjected to punching processing so as to have an appropriate shape in accordance with its purpose of use. The pressure-sensitive adhesive layer is not limited to one continuously formed, but may be one formed into a regular pattern, such as, for example, a dot shape and a stripe shape, or formed into a random pattern.

The aforementioned substrate can be formed of a material appropriately selected, in accordance with the application of the pressure-sensitive adhesive tape, from the group consisting of, for example: plastic films, such as polyolefin films made of polyethylene, polypropylene, poly-1-butene, poly-4-methyl-1-pentene, ethylene propylene copolymer, ethylene 1-butene copolymer, ethylene-vinyl acetate copolymer, ethylene ethyl acrylate copolymer, and ethylene vinyl alcohol copolymer, polyester films made of polyethylene terephthalate, polyethylenenaphthalate, and polybutylene terephthalate, polyacrylate film, polystyrene films, polyamide films made of nylon 6, nylon 6, 6, and partially aromatic polyamide, polyvinylchloride film, polyvinylidene chloride film, and polycarbonate film; foam substrates, such as a polyurethane foam, and polyethylene foam; paper, such as craft paper, crepe paper, and Japanese paper; cloth, such as cotton cloth and staple fiber cloth; nonwoven cloth, such as polyester nonwoven fabric and vinylon nonwoven fabric; metallic foils, such as aluminum foil and copper foil; and the like.

The substrate can also be subjected to, if necessary: a mold-release and antifouling treatment using a release agent, such as a silicone release agent, fluorine release agent, long-chain alkyl release agent, or fatty acid amide release agent, and a silica powder; an easy-adhesion treatment, such as an acid treatment, alkali treatment, primer treatment, corona treatment, plasma treatment, ultraviolet treatment, or the like; and an antistatic treatment, such as a coating type, kneading type, deposition type, or the like. The thickness of the substrate can be appropriately selected in accordance with its purpose, but is generally within a range of approximately 5 μm to 200 μm (typically within a range of 10 μm to 100 μm).

In order to protect the pressure-sensitive adhesive surface, a release liner can be attached, if necessary, to the surface of the pressure-sensitive adhesive layer in the pressure-sensitive adhesive sheet according to the present embodiment.

Although paper or a plastic film can be used as a material for forming the release liner, a plastic film is preferably used because it is excellent in surface smoothness. The film is not particularly limited as far as it can protect the pressure-sensitive adhesive layer. Examples of the film include, for example, a polyethylene film, polypropylene film, polybutene film, polybutadiene film, polymethylpentene film, polyvinylchloride film, vinylchloride copolymer film, polyethylene terephthalate film, polybutylene terephthalate film, polyurethane film, and ethylene-vinylacetate copolymer film, etc.

The thickness of the release liner is usually within a range of 5 μm to 200 μm, and preferably within a range of approximately 10 μm to 100 μm. When the thickness is within the aforementioned range, the release liner is excellent in the workability for attaching to the pressure-sensitive adhesive layer and the workability for releasing therefrom, and hence the release liner is preferred. The release liner can also be subjected to, if necessary: a mold-release and antifouling treatment using a release agent, such as a silicone release agent, fluorine release agent, long-chain alkyl release agent, or fatty acid amide release agent, and a silica powder; and an antistatic treatment, such as a coating type, kneading type, deposition type, or the like.

The pressure-sensitive adhesive sheet has the properties that: the pressure-sensitive adhesive force thereof is small immediately after being attached to an adherend, and hence rework can be performed; the pressure-sensitive adhesive force is increased over time; and the adhesion reliability is high. The pressure-sensitive adhesive force, occurring immediately after the pressure-sensitive adhesive sheet has been attached (after 30 minutes at room temperature), can be evaluated by a 180°-peeling pressure-sensitive adhesive force test performed under the conditions in which a tensile speed is 300 mm/min and a peeling angle is 180°. In particular, the pressure-sensitive adhesive force smaller than or equal to 2.5 N/25 mm is determined to be good. The 180°-peeling pressure-sensitive adhesive force is preferably 2.0 N/25 mm or smaller, and more preferably 1.0 N/25 mm or smaller. The 180°-peeling pressure-sensitive adhesive force test is performed according to the method and conditions described in the later-described Examples.

In addition, the pressure-sensitive adhesive force of the pressure-sensitive adhesive sheet, occurring over time, can be evaluated by a 180°-peeling pressure-sensitive adhesive force test performed under the conditions in which a tensile speed is 300 mm/min and a peeling angle is 180°. In particular, the pressure-sensitive adhesive force larger than or equal to 5.0N/25 mm is determined to be good. The 180°-peeling pressure-sensitive adhesive is preferably 6.0 N/25 mm or larger, and more preferably 7.0 N/25 mm or larger. The 180°-peeling pressure-sensitive adhesive force test is performed according to the method and conditions described in the later-described Examples.

Further, the pressure-sensitive adhesive sheet has the property that the transparency is high. The transparency of the sheet can be evaluated by a haze. The pressure-sensitive adhesive sheet can be determined to be good when the haze is smaller than 7%. The haze is preferably less than 5%, and more preferably less than 3.5%. The haze is measured according to the method and detailed conditions described in the later-described Examples.

[Optical Film with Pressure-Sensitive Adhesive Layer]

Further, the present invention provides an optical film with a pressure-sensitive adhesive layer made by forming the pressure-sensitive adhesive composition on at least one surface of the optical film. Examples of the optical film that can be used in the present invention include a polarizing plate, wavelength plate, optical compensation film, light diffusion sheet, reflective sheet, anti-reflection sheet, brightness enhancement film, and transparent conductive film (ITO film), etc., which can be used in image display apparatuses, such as a liquid crystal display, plasma display, and organic EL display.

A method of forming the pressure-sensitive adhesive layer on at least one surface of the optical film is not particularly limited, and the layer may be formed by coating the pressure-sensitive adhesive composition according to the present embodiment directly on the surface of the optical film. Alternatively, the pressure-sensitive adhesive layer may be formed by forming the pressure-sensitive adhesive layer on the release liner and by transferring the layer onto the optical film with the surface of the pressure-sensitive adhesive being attached to the optical film. The thickness of the pressure-sensitive adhesive layer in the optical film with the pressure-sensitive adhesive layer is preferably within a range of 3 μm to 200 μm, more preferably within a range of 5 μm to 150 μm, and still more preferably within a range of 10 μm to 100 μm.

The pressure-sensitive adhesive sheet according to the present embodiment has the properties that: the pressure-sensitive adhesive force thereof is as small as the extent in which rework can be performed in the early stage of attachment; the pressure-sensitive adhesive sheet is firmly adhered to an adherend in the subsequent stage; and the pressure-sensitive adhesive layer thereof is excellent in transparency. Because of the above properties, the pressure-sensitive adhesive sheet can be preferably used, other than the aforementioned optical applications, as materials for joining members in mobile devices and other electric and electrical devices or materials for joining various members in automobiles and home electronic appliances, etc.

### EXAMPLES

Hereinafter, the present invention will be described in detail based on Examples, but the invention should not be limited at all by these Examples.

The components of the pressure-sensitive adhesive compositions of Examples 1 to 7 and Comparative Examples 1 to 6 are shown in Table 1.

TABLE 1

| | | | | | | | POLYFUNCTIONAL | |
|---|---|---|---|---|---|---|---|---|
| | POLYMER (A) | | POLYMER (B) | | | | MONOMER | |
| | COMPOISITION | NUMBER | | | | NUMBER | | NUMBER |
| | (wt %) | OF PARTS | No. | COMPOISITION (wt %) | Mw | OF PARTS | MONOMER | OF PARTS |
| EXAMPLE 1 | 2EHA/NVP = 86/14 | 100 | POLYMER 1 | PME-400/DCPMA = 80/20 | 4700 | 5 | TMPTA | 0.1 |
| EXAMPLE 2 | 2EHA/NVP = 86/14 | 100 | POLYMER 1 | PME-400/DCPMA = 80/20 | 4700 | 10 | TMPTA | 0.1 |
| EXAMPLE 3 | 2EHA/NVP = 86/14 | 100 | POLYMER 2 | PME-400/IBXMA = 80/20 | 3600 | 5 | TMPTA | 0.1 |
| EXAMPLE 4 | 2EHA/NVP = 86/14 | 100 | POLYMER 3 | PME-400/CHMA = 80/20 | 4800 | 5 | TMPTA | 0.1 |
| EXAMPLE 5 | 2EHA/NVP = 86/14 | 100 | POLYMER 4 | PME-400/DCPMA = 90/10 | 4000 | 5 | TMPTA | 0.1 |
| EXAMPLE 6 | 2EHA/NVP = 86/14 | 100 | POLYMER 5 | CD552/DCPMA = 80/20 | 3800 | 5 | TMPTA | 0.1 |
| EXAMPLE 7 | 2EHA/NVP = 86/14 | 100 | POLYMER 3 | PME-400/CHMA = 80/20 | 4800 | 10 | TMPTA | 0.1 |
| COMPARATIVE | 2EHA/NVP = 86/14 | 100 | — | — | — | — | TMPTA | 0.1 |
| EXAMPLE 1 | | | | | | | | |
| COMPARATIVE | 2EHA/NVP = 86/14 | 100 | POLYMER 6 | PE-200 = 100 | 3300 | 10 | TMPTA | 0.1 |
| EXAMPLE 2 | | | | | | | | |
| COMPARATIVE | 2EHA/NVP = 86/14 | 100 | POLYMER 7 | PP-1000 = 100 | 5200 | 10 | TMPTA | 0.1 |
| EXAMPLE 3 | | | | | | | | |
| COMPARATIVE | 2EHA/NVP = 86/14 | 100 | | SANNIX PP-2000 | 2000 | 5 | TMPTA | 0.1 |
| EXAMPLE 4 | | | | | | | | |
| COMPARATIVE | 2EHA/NVP = 86/14 | 100 | | UNIOX M-400 | 400 | 5 | TMPTA | 0.1 |
| EXAMPLE 5 | | | | | | | | |
| COMPARATIVE | 2EHA/NVP = 86/14 | 100 | POLYMER 8 | PME-400/2EHA = 80/20 | 4200 | 5 | TMPTA | 0.1 |
| EXAMPLE 6 | | | | | | | | |

The abbreviations in Table 1 represent the following compounds.

2EHA: 2-Ethylhexyl Acrylate

HEA: 2-Hydroxyethyl Acrylate

DCPMA: Dicyclopentanyl Methacrylate

MMA: Methyl Methacrylate

IBXMA: Isobornyl Methacrylate

CHMA: Cyclohexyl Methacrylate

### (Preparation of Acrylic Polymer Syrup (2EHA/NVP=86/14) as (A) Component)

Eighty six parts by mass of 2-ethylhexyl acrylate (2EHA), 14 parts by mass of N-vinyl-2-pyrrolidone (NVP), 0.05 parts by mass of a photo-polymerization initiator (product name: IRGACURE 184, made by BASF), and 0.05 parts by mass of a photo-polymerization initiator (product name: IRGACURE 651, made by BASF) were placed into a 4-neck flask. A partial polymer (acrylic polymer syrup) having a rate of polymerization of approximately 8% by mass was obtained by exposing the mixture to UV rays under a nitrogen atmosphere such that the mixture was partially photo-polymerized.

### (Preparation of (Meth)acrylic Polymer 1 (PME-400/DCPMA=80/20) as (B) Component)

One hundred parts by mass of ethyl acetate, 80 parts by mass of methoxy polyethylene glycol methacrylate in which the average added mole number of an oxyethylene unit is 9 (product name: BLEMMER PME-400, made by NOF CORPORATION), 20 parts by mass of dicyclopentanyl methacrylate (DCPMA) (product name: FA-513M, made by Hitachi Chemical Co., Ltd.), and 3 parts by mass of methyl thioglycolate, as a chain transfer agent, were placed into a 4-neck flask provided with a stirring blade, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 5 hours. The weight average molecular weight of the obtained (meth)acrylic polymer 1 was 4700.

### (Preparation of (Meth)acrylic Polymer 2 (PME-400/IBXMA=80/20) as (B) Component)

One hundred parts by mass of ethyl acetate, 80 parts by mass of methoxy polyethylene glycol methacrylate in which the average added mole number of an oxyethylene unit is 9 (product name: BLEMMER PME-400, made by NOF CORPORATION), 20 parts by mass of isobornyl methacrylate (IBXMA), and 3 parts by mass of methyl thioglycolate, as a chain transfer agent, were placed into a 4-neck flask provided with a stirring blade, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 5 hours. The weight average molecular weight of the obtained (meth)acrylic polymer 2 was 3600.

### (Preparation of (Meth)acrylic Polymer 3 (PME-400/CHMA=80/20) as (B) Component)

One hundred parts by mass of ethyl acetate, 80 parts by mass of methoxy polyethylene glycol methacrylate in which the average added mole number of an oxyethylene unit is 9 (product name: BLEMMER PME-400, made by NOF CORPORATION), 20 parts by mass of cyclohexyl methacrylate (CHMA), and 3 parts by mass of methyl thioglycolate, as a chain transfer agent, were placed into a 4-neck flask provided with a stirring blade, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 5 hours. The weight average molecular weight of the obtained (meth)acrylic polymer 3 was 4800.

(Preparation of (Meth)acrylic Polymer 4 (PME-400/DCPMA=90/10) as (B) component)

One hundred parts by mass of ethyl acetate, 90 parts by mass of methoxy polyethylene glycol methacrylate in which the average added mole number of an oxyethylene unit is 9 (product name: BLEMMER PME-400, made by NOF CORPORATION), 10 parts by mass of dicyclopentanyl methacrylate (DCPMA) (product name: FA-513M, made by Hitachi Chemical Co., Ltd.), and 3 parts by mass of methyl thioglycolate, as a chain transfer agent, were placed into a 4-neck flask provided with a stirring blade, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 5 hours. The weight average molecular weight of the obtained (meth)acrylic polymer 4 was 4000.

(Preparation of (Meth)acrylic polymer 5 (CD552/DCPMA=80/20) as (B) Component)

One hundred parts by mass of ethyl acetate, 80 parts by mass of methoxy polyethylene glycol methacrylate in which the average added mole number of an oxyethylene unit is 12 (product name: CD552, made by Sartomer Co.), 20 parts by mass of dicyclopentanyl methacrylate (DCPMA) (product name: FA-513M, made by Hitachi Chemical Co., Ltd.), and 3 parts by mass of methyl thioglycolate, as a chain transfer agent, were placed into a 4-neck flask provided with a stirring blade, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 5 hours. The weight average molecular weight of the obtained (meth)acrylic polymer 5 was 3800.

### (Preparation of (Meth)acrylic Polymer 6 (PE-200=100) as (B) Component)

One hundred parts by mass of ethyl acetate, 100 parts by mass of polyethylene glycol methacrylate in which the average added mole number of an oxyethylene unit is 4 (product name: BLEMMER PE-200, made by NOF CORPORATION), and 3 parts by mass of methyl thioglycolate, as a chain transfer agent, were placed into a 4-neck flask provided with a stirring blade, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 5 hours. The weight average molecular weight of the obtained (meth)acrylic polymer 6 was 3300.

### (Preparation of (Meth)acrylic Polymer 7 (PP-1000=100) as (B) Component)

One hundred parts by mass of ethyl acetate, 100 parts by mass of polypropylene glycol methacrylate in which the average added mole number of an oxyethylene unit is 4 to 6 (product name: PP-1000, made by NOF CORPORATION), and 3 parts by mass of methyl thioglycolate, as a chain transfer agent, were placed into a 4-neck flask provided with a stirring blade, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 5 hours. The weight average molecular weight of the obtained (meth)acrylic polymer 7 was 5200.

### (Preparation of (Meth)acrylic Polymer 8 (PME-400/2EHA=80/20) as (B) Component)

One hundred parts by mass of ethyl acetate, 80 parts by mass of methoxy polyethylene glycol methacrylate in which the average added mole number of an oxyethylene unit is 9 (product name: PME-400, made by NOF CORPORATION), 20 parts by mass of 2-ethylhexyl acrylate (2EHA), and 3 parts by mass of methyl thioglycolate, as a chain transfer agent, were placed into a 4-neck flask provided with a stirring blade, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 5 hours. The weight average molecular weight of the obtained (meth)acrylic polymer 8 was 4200.

### Example 1

### Preparation of Acrylic Pressure-Sensitive Adhesive Composition

After 5 parts by mass of the aforementioned (meth)acrylic polymer 1 and 0.1 parts by mass of trimethylolpropane triacrylate (TMPTA) were added to 100 parts by mass of the aforementioned acrylic polymer syrup, these were mixed uniformly to prepare an acrylic pressure-sensitive adhesive composition.

### (Production of Acrylic Pressure-Sensitive Adhesive Layer)

A coated layer having a final thickness of 50 μm was formed by coating the aforementioned acrylic pressure-sensitive adhesive composition on one surface of a polyester film having a thickness of 38 μm (product name: Diafoil MRF, made by Mitsubishi Plastics Inc.), the one surface having been subjected to a release treatment with silicone. Subsequently, the surface of the coated acrylic pressure-sensitive adhesive composition was covered with one surface of a polyester film having a thickness of 38 μm (product name: Diafoil MRN, made by Mitsubishi Plastics Inc.), the one surface having been subjected to a release treatment with silicone, so that the one surface of the film was located near to the coated layer. Thereby, oxygen was blocked from the coated layer of the acrylic pressure-sensitive adhesive composition (acrylic pressure-sensitive adhesive composition layer). An acrylic pressure-sensitive adhesive layer was obtained by irradiating, for 360 seconds, the coated layer thus obtained with ultraviolet rays having an illuminance of 5 mW/cm² (measured by TOPCON UVR-T1 having a maximum sensitivity at approximately 350 nm) with the use of a chemical light lamp (made by TOSHIBA CORPORATION) in order to polymerize the composition. The polyester film covering each of the surfaces of the pressure-sensitive adhesive layer functions as a release liner.

### Example 2

An acrylic pressure-sensitive adhesive composition was prepared in the same way as in Example 1, except that 10 parts by mass of the (meth)acrylic polymer 1 were used, instead that 5 parts by mass of the (meth)acrylic polymer 1 were used; and an acrylic pressure-sensitive adhesive layer was obtained in the same way as in Example 1.

### Example 3

An acrylic pressure-sensitive adhesive composition was prepared in the same way as in Example 1, except that 5 parts by mass of the (meth)acrylic polymer 2 were used, instead that 5 parts by mass of the (meth)acrylic polymer 1 were used; and an acrylic pressure-sensitive adhesive layer was obtained in the same way as in Example 1.

### Example 4

An acrylic pressure-sensitive adhesive composition was prepared in the same way as in Example 1, except that 5 parts by mass of the (meth)acrylic polymer 3 were used, instead that 5 parts by mass of the (meth)acrylic polymer 1 were used; and an acrylic pressure-sensitive adhesive layer was obtained in the same way as in Example 1.

### Example 5

An acrylic pressure-sensitive adhesive composition was prepared in the same way as in Example 1, except that 5 parts by mass of the (meth)acrylic polymer 4 were used, instead that 5 parts by mass of the (meth)acrylic polymer 1 were used; and an acrylic pressure-sensitive adhesive layer was obtained in the same way as in Example 1.

### Example 6

An acrylic pressure-sensitive adhesive composition was prepared in the same way as in Example 1, except that 5 parts by mass of the (meth)acrylic polymer 5 were used, instead that 5 parts by mass of the (meth)acrylic polymer 1 were used; and an acrylic pressure-sensitive adhesive layer was obtained in the same way as in Example 1.

### Example 7

An acrylic pressure-sensitive adhesive composition was prepared in the same way as in Example 1, except that 10 parts by mass of the (meth)acrylic polymer 3 were used, instead that 5 parts by mass of the (meth)acrylic polymer 1 were used; and an acrylic pressure-sensitive adhesive layer was obtained in the same way as in Example 1.

### Comparative Example 1

An acrylic pressure-sensitive adhesive composition was prepared in the same way as in Example 1, except that the (meth)acrylic polymer 1 was not used; and an acrylic pressure-sensitive adhesive layer was obtained in the same way as in Example 1.

### Comparative Example 2

An acrylic pressure-sensitive adhesive composition was prepared in the same way as in Example 1, except that 10 parts by mass of the (meth)acrylic polymer 6 were used, instead that 5 parts by mass of the (meth)acrylic polymer 1 were used; and an acrylic pressure-sensitive adhesive layer was obtained in the same way as in Example 1.

### Comparative Example 3

An acrylic pressure-sensitive adhesive composition was prepared in the same way as in Example 1, except that 10 parts by mass of the (meth)acrylic polymer 7 were used, instead that 5 parts by mass of the (meth)acrylic polymer 1 were used; and an acrylic pressure-sensitive adhesive layer was obtained in the same way as in Example 1.

### Comparative Example 4

An acrylic pressure-sensitive adhesive composition was prepared in the same way as in Example 1, except that 5 parts by mass of polyoxypropylene glycol whose number average molecular weight is 2000 (product name: SANNIX PP-2000, made by Sanyo Chemical Industries, Ltd.) were used, instead that 5 parts by mass of the (meth)acrylic polymer 1 were used; and an acrylic pressure-sensitive adhesive layer was obtained in the same way as in Example 1.

### Comparative Example 5

An acrylic pressure-sensitive adhesive composition was prepared in the same way as in Example 1, except that 5 parts by mass of polyoxyethylene ethyl ether whose average molecular weight is 400 (product name: Uniox M-400, made by NOF CORPORATION) were used, instead that 5 parts by mass of the (meth)acrylic polymer 1 were used; and an acrylic pressure-sensitive adhesive layer was obtained in the same way as in Example 1.

### Comparative Example 6

An acrylic pressure-sensitive adhesive composition was prepared in the same way as in Example 1, except that 5 parts by mass of the (meth)acrylic polymer 8 were used, instead that 5 parts by mass of the (meth)acrylic polymer 1 were used; and an acrylic pressure-sensitive adhesive layer was obtained in the same way as in Example 1.

### (Test Method)

### <Measurement of Molecular Weight>

The weight average molecular weight of a (meth)acrylic copolymer was determined by using a GPC apparatus (product name: HLG-8220GPC, made by TOSOH CORP.). Measurement conditions were as follows and the molecular weight was determined by standard polystyrene conversion.

*Sample concentration: 0.2 wt % (tetrahydrofuran (THF) solution)

*Sample injection volume: 10 μl

*Eluent: THF

*Flow Rate: 0.6 ml/min

*Measuring temperature: 40° C.

*Column:
Sample column; TSKguardcolumn SuperHZ-H (one column1)+TSKgel SuperHZM-H (two columns)
Reference column; TSKgel SuperH-RC (one column)

*Detector: differential refractometer (RI)

### (Measurement of Ratio of Solvent-Insoluble Component)

A ratio of a solvent-insoluble component was determined in the following way: after 0.1 g of a pressure-sensitive adhesive composition was sampled and precisely weighed (mass before dipping), the sampled composition was dipped in 50 ml of ethyl acetate at room temperature (20 to 25° C.) for 1 week; a solvent (ethyl acetate) insoluble component was taken out to be dried at 130° C. for 2 hours and then weighed (mass after dipping and drying); and the ratio was calculated by using an equation for calculating a “ratio of solvent-insoluble component (% by mass)=[(mass after dipping and drying)/(mass before dipping)]×100”. The results of measuring the ratios of solvent-insoluble components are shown in Table 2.

### [180°-Peeling Pressure-Sensitive Adhesive Force Test]

After the release liner (polyester film) on one surface of the acrylic pressure-sensitive adhesive layer according to each of Examples and Comparative Examples was peeled off, a polyethylene terephthalate film having a thickness of 50 μm was attached. The obtained sheet was cut into a piece having a width of 25 mm, which was used as a test specimen. A glass plate having a thickness of 1.35 mm (part number: #0050, made by Matsunami Glass Ind., Ltd.), which had been cleaned with isopropyl alcohol, was provided. After the release liner (polyester film) on the other surface of the pressure-sensitive adhesive sheet was peeled off, the pressure-sensitive adhesive surface of the sheet was attached to the glass plate by reciprocating a 2-kg roller.

After the pressure-sensitive adhesive sheets were attached to the glass plates, the glass plates were divided into two groups. The glass plates in one group of which were left uncontrolled for 30 minutes (early stage), and those in another group of which were placed under an environment at 40° C. for 48 hours and then left uncontrolled under an environment at 23° C. for 30 minutes (ordinary state). The other end of each of the pressure-sensitive adhesive sheets in the early stage and the ordinary state was peeled off in the 180°-peeling direction at a speed of 300 mm/min. The pressure-sensitive adhesive force (resistance force) (unit: N/25 mm) to the adherend, occurring at the time, was measured. With respect to the glass plate, it was determined to be good when the pressure-sensitive adhesive force was smaller than 2.5 N/25 mm, and determined to be bad when the force was 2.5 N/25 mm or larger, in the early stage. In the ordinary state, it was determined to be good when the force was 5.0 N/25 mm or larger, and determined to be bad when the force was smaller than 5.0 N/25 mm. Results of the measurement are shown in Table 2.

### (Transparency Test: Haze)

After the acrylic pressure-sensitive adhesive layer according to each of Examples and Comparative Examples was cut into a piece having a size of 50 mm in width×50 mm in length, the release liner on one surface the layer was peeled off, which was attached to a slide glass having a thickness of 0.8 mm (part number: S-1111, white edge polishing, made by Matsunami Glass Ind., Ltd.) to be used as an evaluation sample. The haze of the sample was measured by a haze meter (made by MURAKAMI COLOR RESEARCH LABORATORY CO., Ltd.). It was determined to be good when the haze was less than 7%, and determined to be bad when the haze was 7% or more. Results of measuring the haze are shown in Table 2.

TABLE 2

| | RATIO OF | PRESSURE-SENSITIVE | | OPTICAL |
|---|---|---|---|---|
| | SOLVENT- | ADHESIVE FORCE | | PROP- |
| | INSOLUBLE | [N/25 mm] | | ERTY |
| | COMPONENT | EARLY | ORDINARY | HAZE |
| | [%] | STAGE | STATE | [%] |
| EXAMPLE 1 | 87.2 | 1.55(◯) | 8.40(◯) | 1.3 |
| EXAMPLE 2 | 83.8 | 0.30(◯) | 7.85(◯) | 1.6 |
| EXAMPLE 3 | 88.5 | 1.66(◯) | 8.90(◯) | 2.8 |
| EXAMPLE 4 | 88.4 | 0.79(◯) | 8.05(◯) | 1.8 |
| EXAMPLE 5 | 88.8 | 0.28(◯) | 7.15(◯) | 1.7 |
| EXAMPLE 6 | 88.1 | 0.50(◯) | 6.40(◯) | 2.8 |
| EXAMPLE 7 | 86.2 | 0.36(◯) | 7.65(◯) | 2.0 |
| COMPARATIVE | 84.2 | 9.10(X) | 11.4(◯) | 1.7 |
| EXAMPLE 1 | | | | |
| COMPARATIVE | 87.5 | 7.55(X) | 10.4(◯) | 2.0 |
| EXAMPLE 2 | | | | |
| COMPARATIVE | 82.4 | 7.00(X) | 7.55(◯) | 1.7 |
| EXAMPLE 3 | | | | |
| COMPARATIVE | 84.0 | 0.10(◯) | 0.50(X) | 1.5 |
| EXAMPLE 4 | | | | |
| COMPARATIVE | 83.6 | 0.05(◯) | 0.20(X) | 1.5 |
| EXAMPLE 5 | | | | |
| COMPARATIVE | 87.7 | 0.10(◯) | 2.10(X) | 1.7 |
| EXAMPLE 6 | | | | |

The embodiments described above will be summarized below.

(Item 1) A pressure-sensitive adhesive composition comprising: 100 parts by mass of a polymer (A) having a glass transition temperature lower than 0° C.; and 0.05 parts by mass to 20 parts by mass of a (meth)acrylic polymer (B) having a weight average molecular weight (MwB) of 1000≦MwB<30000 that contains, as monomer units, both a (meth)acrylic monomer having an alicyclic structure represented by the following general formula (1) and a monomer having a polyoxyalkylene skeleton:

CH₂═C(R¹)COOR² (1)

[wherein R¹ represents a hydrogen atom or a methyl group and R² represents an alicyclic hydrocarbon group having an alicyclic structure.]

(Item 2) The pressure-sensitive adhesive composition according to item 1, in which the polymer (A) is an acrylic polymer.

(Item 3) The acrylic pressure-sensitive adhesive composition according to item 2, in which the acrylic polymer contains, as a monomer unit, at least one monomer selected from the group consisting of N-vinyl cyclic amides represented by the following general formula (M1) and hydroxyl group-containing monomers:

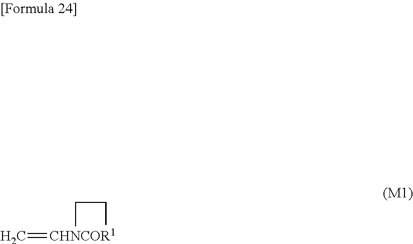

wherein R¹ is a divalent organic group.

(Item 4) The pressure-sensitive adhesive composition according to any one of items 1 to 3, in which an alicyclic hydrocarbon group in the (meth)acrylic monomer having an alicyclic structure has a bridged ring structure.

(Item 5) The pressure-sensitive adhesive composition according to any one of items 1 to 4, in which the monomer having a polyoxyalkylene skeleton is an oxyalkylene group-containing monomer in which the average added mole number of an oxyalkylene unit represented by the following general formula (2) is 3 to 40:

[Formula 25]

CH₂═C(R₁)—COO—(CₘH₂ₘO)ₙ—(CₚH₂ₚO)_{q}—R₂ (2)

[wherein R₁ represents hydrogen or a methyl group, R₂ represents hydrogen or a monovalent organic group, m and p represent integers of 2 to 4, and n and q represent integers of 0 or 2 to 40 that are not 0 at a time.]

(Item 6) A pressure-sensitive adhesive layer made of the pressure-sensitive adhesive composition according to any one of items 1 to 5.

(Item 7) The pressure-sensitive adhesive layer according to item 6 containing 55.0 to 99.0% by mass of a solvent-insoluble component.

(Item 8) A pressure-sensitive adhesive sheet made by forming the pressure-sensitive adhesive layer according to item 6 or item 7 on at least one surface of a substrate.

(Item 9) An optical film with a pressure-sensitive adhesive layer made by forming the pressure-sensitive adhesive layer according to item 6 or item 7 on at least one surface of the optical film.

What is claimed is:

1. A pressure-sensitive adhesive composition comprising:
100 parts by mass of a polymer (A) having a glass transition temperature lower than 0° C.; and
0.05 parts by mass to 20 parts by mass of a (meth)acrylic polymer (B) having a weight average molecular weight (MwB) of 1000≦MwB<30000 that contains, as monomer units, both a (meth)acrylic monomer having an alicyclic structure represented by the following general formula (1) and a monomer having a polyoxyalkylene skeleton:
CH₂═C(R¹)COOR² (1)
[wherein R¹ represents a hydrogen atom or a methyl group and R² represents an alicyclic hydrocarbon group having an alicyclic structure.]

2. The pressure-sensitive adhesive composition according to claim 1, wherein
the polymer (A) is an acrylic polymer.

3. The acrylic pressure-sensitive adhesive composition according to claim 2, wherein
the acrylic polymer contains, as a monomer unit, at least one monomer selected from the group consisting of N-vinyl cyclic amides represented by the following general formula (M1) and hydroxyl group-containing monomers: 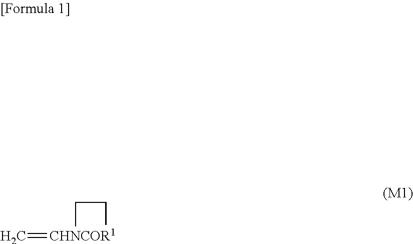
wherein R¹ is a divalent organic group.

4. The pressure-sensitive adhesive composition according to claim 1, wherein
an alicyclic hydrocarbon group in the (meth)acrylic monomer having an alicyclic structure has a bridged ring structure.

5. The pressure-sensitive adhesive composition according to claim 1, wherein
the monomer having a polyoxyalkylene skeleton is an oxyalkylene group-containing monomer in which the average added mole number of an oxyalkylene unit represented by the following general formula (2) is 3 to 40:
[Formula 2]
CH₂═C(R₁)—COO—(CₘH₂ₘO)ₙ—(CₚH₂ₚO)_{q}—R₂ (2)
[wherein R₁ represents hydrogen or a methyl group, R₂ represents hydrogen or a monovalent organic group, m and p represent integers of 2 to 4, and n and q represent integers of 0 or 2 to 40 that are not 0 at a time.]

6. The pressure-sensitive adhesive layer made of the pressure-sensitive adhesive composition according to claim 1.

7. The pressure-sensitive adhesive layer according to claim 6 containing 55.0 to 99.0% by mass of a solvent-insoluble component.

8. A pressure-sensitive adhesive sheet made by forming the pressure-sensitive adhesive layer according to claim 6 on at least one surface of a substrate.

9. An optical film with a pressure-sensitive adhesive layer made by forming the pressure-sensitive adhesive layer according to claim 6 on at least one surface of the optical film.

10. The pressure-sensitive adhesive composition according to claim 2, wherein
an alicyclic hydrocarbon group in the (meth)acrylic monomer having an alicyclic structure has a bridged ring structure.

11. The pressure-sensitive adhesive composition according to claim 3, wherein
an alicyclic hydrocarbon group in the (meth)acrylic monomer having an alicyclic structure has a bridged ring structure.

12. The pressure-sensitive adhesive composition according to claim 2, wherein
the monomer having a polyoxyalkylene skeleton is an oxyalkylene group-containing monomer in which the average added mole number of an oxyalkylene unit represented by the following general formula (2) is 3 to 40.

13. The pressure-sensitive adhesive composition according to claim 3, wherein
the monomer having a polyoxyalkylene skeleton is an oxyalkylene group-containing monomer in which the average added mole number of an oxyalkylene unit represented by the following general formula (2) is 3 to 40.

14. The pressure-sensitive adhesive composition according to claim 4, wherein
the monomer having a polyoxyalkylene skeleton is an oxyalkylene group-containing monomer in which the average added mole number of an oxyalkylene unit represented by the following general formula (2) is 3 to 40.

15. The pressure-sensitive adhesive composition according to claim 10, wherein
the monomer having a polyoxyalkylene skeleton is an oxyalkylene group-containing monomer in which the average added mole number of an oxyalkylene unit represented by the following general formula (2) is 3 to 40.

16. The pressure-sensitive adhesive composition according to claim 11, wherein
the monomer having a polyoxyalkylene skeleton is an oxyalkylene group-containing monomer in which the average added mole number of an oxyalkylene unit represented by the following general formula (2) is 3 to 40.

17. A pressure-sensitive adhesive layer made by the pressure-sensitive adhesive composition according to claim 2.

18. A pressure-sensitive adhesive layer made by the pressure-sensitive adhesive composition according to claim 3.

19. A pressure-sensitive adhesive layer made by the pressure-sensitive adhesive composition according to claim 4.

20. A pressure-sensitive adhesive layer made by the pressure-sensitive adhesive composition according to claim 5.
